(19) United States
(12) Patent Application Publication
(10) Pub. No.: US 2007/0188525 A1
(43) Pub. Date: Aug. 16, 2007

(54) Image processing method and apparatus and image display apparatus

(75) Inventors: Satoshi Yamanaka, Tokyo (JP); Yoshiaki Okuno, Tokyo (JP); Shuichi Kagawa, Tokyo (JP); Jun Someya, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/704,249

(22) Filed: Feb. 9, 2007

(30) Foreign Application Priority Data
Feb. 13, 2006 (JP) 2006-034680

(51) Int. Cl. G09G 5/10

(52) U.S. Cl. 345/690

(57) ABSTRACT

An image processing method extends n-bit input image data by α bits to generate (n+α)-bit source data, where n and α are positive integers, and smoothes the source data. The maximum difference between gray levels of the unsmoothed source data in an area localized around each pixel is calculated, and a mixing ratio is determined from the maximum difference. The smoothed and unsmoothed source data are mixed according to the mixing ratio to generate output image data. In areas with gradually changing gray levels, the output image data are weighted toward the smoothed source data, mitigating image degradation due to quantization and gamma correction. In areas with sharp edges, the output image data are weighted toward the unsmoothed source data, preventing a loss of edge sharpness.

### BACKGROUND OF THE INVENTION

1. Field of the Invention

The present invention relates to an image processing method, an image processing apparatus, and an image display apparatus, more particularly to technology for extending the gray scale of a digital image.

2. Description of the Related Art

Various types of gray-scale manipulations are performed during image processing. A problem is that these manipulations sometimes cause gray-scale jumps: staircase-like changes that skip over intermediate gray levels instead of changing smoothly from one gray level to the next (see Japanese Patent Application Publication No. 10-84481, p. 3, FIGS. 1 and 2).

When an analog image signal is converted to a digital image data, its continuous gray scale is separated into discrete levels by a quantization process. If the resolution of the quantization process is low (the number of bits per picture element or pixel is small), much of the gray scale cannot be expressed and the image is visibly degraded. If the quantization resolution is raised, image quality is improved but a more expensive analog-to-digital converter is required, which is another problem.

The Japanese patent application cited above addresses the problem that gray-scale jumps may be perceived as unintended edges (false edges). This problem can also be caused by low-resolution analog-to-digital conversion, especially when an analog image signal with gradually varying gray levels is converted to digital image data, because in the digital image data, changes by even one gray level may stand out. For example, changes by one gray level may become visible in an image of a sunset or the surface of the sea, producing unwanted false edges.

Yet another problem is that when a gray-scale transformation such as a gamma correction is carried out on digital image data to compensate for a nonlinear relationship between the input signal and the output intensity of the display device, distinct gray levels may collapse to the same value because not all of the original gray levels can be expressed in the converted data.

### SUMMARY OF THE INVENTION

An object of the present invention is to mitigate image degradation due to quantization and image degradation due to gray-scale transformations such as gamma correction, without causing a loss of edge sharpness in images with sharp edges.

The invention provides an image processing method that starts by extending n-bit input image data by α bits per pixel to generate (n+α)-bit source data, where n and α are positive integers. The (n+α)-bit source data describe the same image as the n-bit input image data. The source data are then smoothed by modifying the source data of each pixel according to the source data in an area localized around the pixel. The smoothed data describe a smoothed image with additional gray levels interpolated between the gray levels of the input image data.

For each pixel, a maximum difference between gray levels of the input image data or source data in the area from which the smoothed value of the pixel was calculated is obtained. This maximum difference may be the maximum difference between the values of pixels separated by not more than a predetermined distance within the area. A mixing ratio is calculated for each pixel, the mixing ratio increasing as the maximum difference decreases. The smoothed data and the source data are mixed according to the mixing ratio, the mixing proportion of the smoothed data increasing as the mixing ratio increases, and the resulting mixed image data are output.

In an area in which the gray level of the input image is changing gradually, the maximum difference is comparatively low, so the output image data are weighted toward the smoothed data and change gradually, mitigating image degradation due to quantization, gamma correction, etc. by preventing the formation of perceptible false edges.

In an area with a sharp edge at which the gray level of the input image changes abruptly, the maximum difference is comparatively high, so the output image data are weighted toward the source data and change abruptly, preventing a loss of edge sharpness.

### BRIEF DESCRIPTION OF THE DRAWINGS

In the attached drawings:

FIG. 1 is a block diagram showing the structure of an image display apparatus in a first embodiment of the invention;

FIGS. 2A to 2G are graphs illustrating the operation of the image display apparatus in the first embodiment;

FIG. 3 illustrates the operation of the data smoother in FIG. 1;

FIGS. 4A to 4C illustrate the operation of the maximum difference calculator in FIG. 1;

FIG. 5 is a block diagram showing the structure of the maximum difference calculator in FIG. 1;

FIGS. 6A and 6B are graphs illustrating the operation of the maximum difference calculator in FIG. 1;

FIGS. 7A to 7G illustrate the operation of the maximum difference calculator in FIG. 1;

FIGS. 8A and 8B are graphs illustrating the operation of the mixing ratio generator in FIG. 1;

FIGS. 9A to 9G are graphs illustrating the operation of the image display apparatus in the first embodiment;

FIG. 10 is a flowchart illustrating the operation of the image display apparatus in the first embodiment;

FIG. 11 is a block diagram showing the structure of an image display apparatus in a second embodiment;

FIG. 12 is a block diagram showing the structure of an image display apparatus in a third embodiment;

FIGS. 13A and 13B are graphs illustrating the operation of the mixing ratio smoother in FIG. 12;

FIG. 14 is a block diagram showing the structure of an image display apparatus in a fourth embodiment of the invention;

FIG. 15 is a block diagram showing the structure of an image display apparatus in a fifth embodiment;

FIGS. 16A to 16D and FIGS. 17A to 17E are graphs illustrating the operation of the fifth embodiment;

FIG. 18 is a flowchart illustrating the operation of the fifth embodiment;

FIG. 19 is a block diagram showing the structure of an image display apparatus in a sixth embodiment;

FIG. 20 is a block diagram showing the structure of an image display apparatus in a seventh embodiment;

FIG. 21 is a block diagram showing the structure of an image display apparatus in an eighth embodiment;

FIG. 22 is a block diagram showing the structure of an image display apparatus in a ninth embodiment;

FIGS. 23A to 23G and FIGS. 24A to 24G are graphs illustrating the operation of the ninth embodiment;

FIG. 25 is a flowchart illustrating the operation of the ninth embodiment; and

FIG. 26 is a block diagram showing the structure of an image display apparatus in a tenth embodiment.

### DETAILED DESCRIPTION OF THE INVENTION

Embodiments of the invention will now be described with reference to the attached drawings, in which like elements are indicated by like reference characters.

### First Embodiment

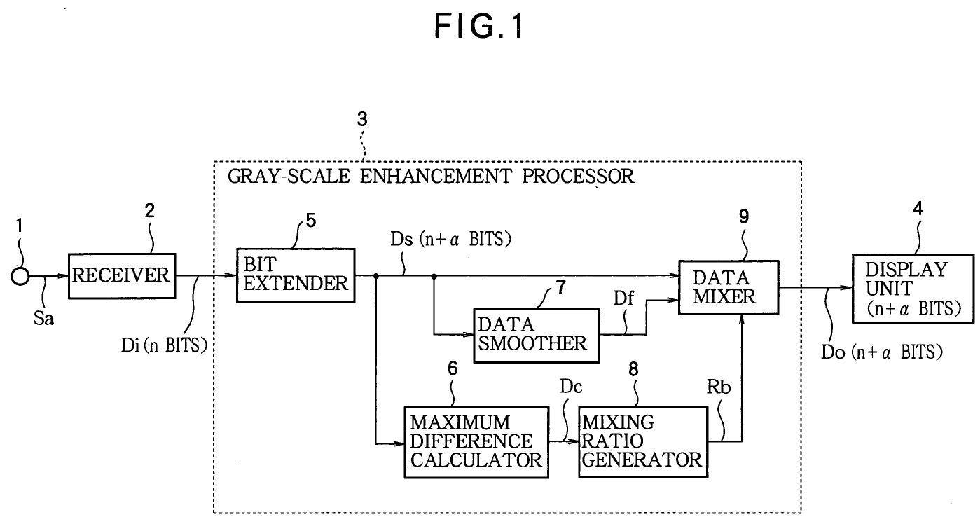

Referring to FIG. 1, a first embodiment of the present invention comprises an input terminal 1, a receiver 2, a gray-scale enhancement processor 3, and a display unit 4.

An analog image signal Sa is input from the input terminal 1 to the receiver 2, which converts it to n-bit image data Di, which are output to the gray-scale enhancement processor 3.

The gray-scale enhancement processor 3, which comprises a bit extender 5, a maximum difference calculator 6, a data smoother 7, a mixing ratio generator 8, and a data mixer 9, converts the n-bit input image data Di to (n+α)-bit mixed image data Do, which are output to the display unit 4. The display unit 4 displays an image according to the mixed image data Do.

The receiver 2 in this embodiment operates as an analog-to-digital converter, but the receiver 2 may also include a tuner preceding the analog-to-digital conversion stage. Alternatively, the receiver 2 may be a digital interface that receives digital data from the input terminal 1 and outputs n-bit image data Di.

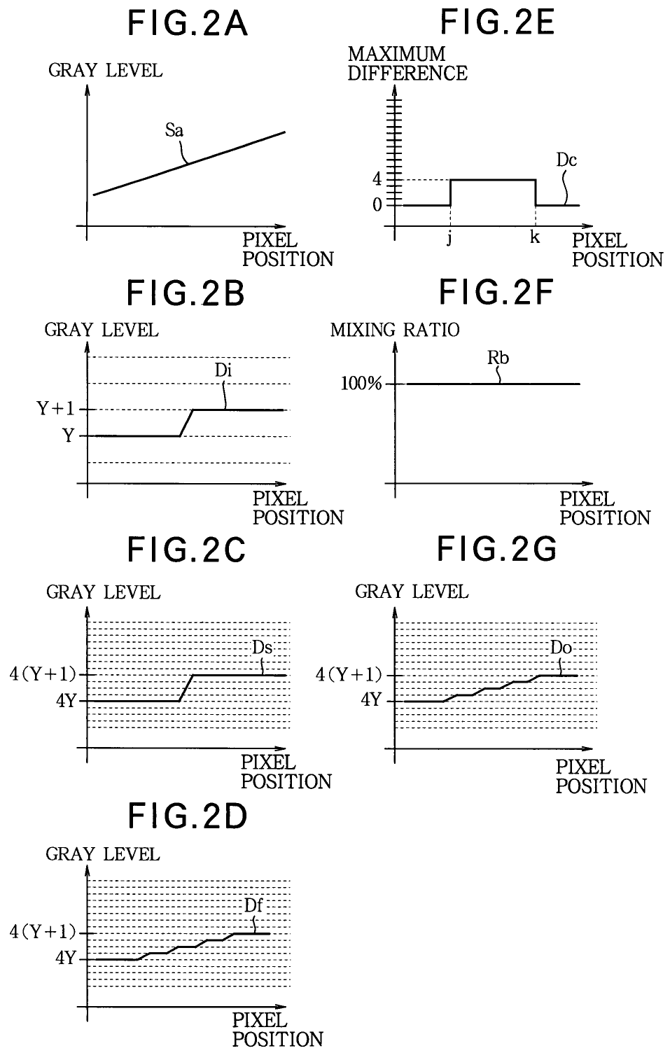

Exemplary signals and data for an input image area with gradually changing gray levels are shown in FIGS. 2A to 2G. FIG. 2A shows the analog image signal Sa input at the input terminal 1. FIG. 2B shows the n-bit image data Di. FIG. 2C shows the (n+α)-bit source data Ds output by the bit extender 5 by adding α bits per pixel. FIG. 2D shows the smoothed data Df output by the data smoother 7 by smoothing the source data Ds. FIG. 2E shows the maximum gray-level difference data Dc generated by the maximum difference calculator 6. FIG. 2F shows the mixing ratio Rb generated by the mixing ratio generator 8. FIG. 2G shows the image data Do output by the data mixer 9. In each of these graphs, the horizontal axis represents pixel position in the vertical or horizontal direction. The vertical axis represents an analog gray level in FIG. 2A, a digital gray level in FIGS. 2B, 2C, 2D, and 2G, the maximum gray-level difference in FIG. 2E, and the mixing ratio in FIG. 2F.

The operation of the first embodiment will now be described with reference to FIGS. 2A to 2G.

The analog image signal Sa shown in FIG. 2A is received by the receiver 2 from the input terminal 1. The receiver 2 converts the analog image signal Sa shown in FIG. 2A to the digital data shown in FIG. 2B, which are output to the bit extender 5.

The gradually rising analog image signal Sa shown in FIG. 2A is converted to the two gray levels (Y and Y+1) in the data Di shown in FIG. 2B because the resolution of the quantization process carried out in the receiver 2 is low (n is small).

The bit extender 5 extends the data of each pixel in the image by appending a zero (‘0’) bits on the right, in effect performing an α-bit left shift toward the most significant bit position, and outputs the resulting (n+α)-bit source data Ds shown in FIG. 2C. The value of α in FIG. 2C is two (α=2), so the n-bit image data are extended to (n+2)-bit image data. Since a two-bit left shift is equivalent to multiplication by four, the gray levels Y and Y+1 of the image data Di in FIG. 2B are converted to 4Y and 4(Y+1), respectively.

The present embodiment is not limited to a two-bit extension. The parameter a may be any positive integer.

The data smoother 7 smoothes the (n+2)-bit source data Ds shown in FIG. 2C by a low-pass filtering (LPF) process and outputs the smoothed data Df shown in FIG. 2D.

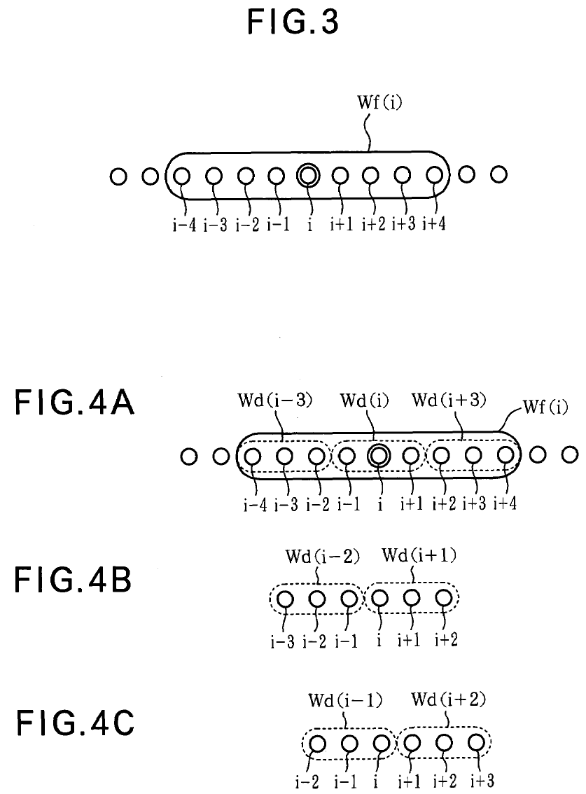

A method of calculating the smoothed data will be described with reference to FIG. 3. Each circle in FIG. 3 represents a pixel.

For each pixel (i), the data smoother 7 uses the pixels included in a smoothing area Wf(i) localized around the pixel (i) to calculate smoothed data Df(i). If, for example, the LPF process is a one-dimensional averaging process that calculates the simple average of nine pixels, the smoothed value of the pixel (i) is calculated as follows:

Df(i)=(Ds(i−4)+Ds(i−3)+Ds(i−2)+Ds(i−1)+Ds(i)+Ds(i+1)+Ds(i+2)+Ds(i+3)+Ds(i+4))/9

### The first embodiment is not limited to a nine-pixel simple averaging process; the smoothing may be performed by any other type of LPF process, with generally similar effects.

The maximum difference calculator 6 outputs the largest short-range difference between gray levels in the smoothing area Wf(i) as the maximum gray-level difference data Dc. The meaning of ‘short-range’ will be explained below.

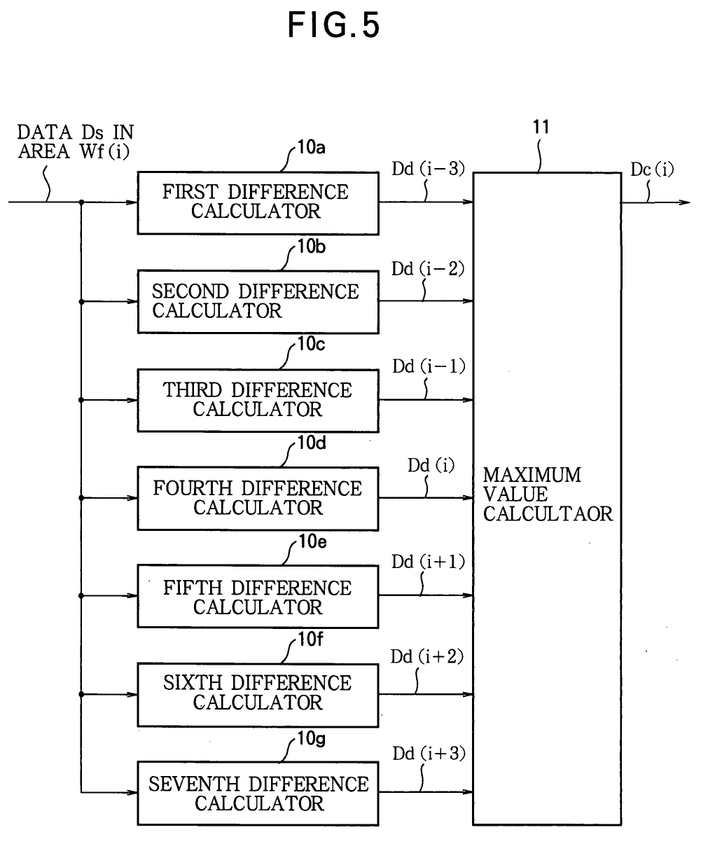

The operation of the maximum difference calculator 6 will be described with reference to FIGS. 4A to 4C and FIG. 5.

The maximum difference calculator 6 calculates gray-level differences within areas smaller than the smoothing area Wf(i). The smoothing area Wf(i) accordingly includes a plurality of gray-level difference calculation areas. By way of example, the gray-level difference calculation areas in FIGS. 4A to 4C include just three consecutive pixels each. There are seven of these areas within the smoothing area Wf(i): an area Wd(i−3) including the pixels from i−4 to i−2, an area Wd(i−2) including the pixels from i−3 to i−1, an area Wd(i−1) including the pixels from i−2 to i, an area Wd(i) including the pixels from i−1 to i+1, an area Wd(i+1) including the pixels from i to i+2, an area Wd(i+2) including the pixels from i+1 to i+3, and an area Wd(i+3) including the pixels from i+2 to i+4.

The seven areas above are numbered according to the pixel at the center of each area. This practice will be adhered to below: the position of an area will be represented by the position of its central pixel, or the closest pixel left of center if there is no pixel at the exact center.

Referring to FIG. 5, the maximum difference calculator 6 comprises a first difference calculator 10a, a second difference calculator 10b, a third difference calculator 10c, a fourth difference calculator 10d, a fifth difference calculator 10e, a sixth difference calculator 10f, a seventh difference calculator 10g, and a maximum value selector 11 that calculate the maximum gray-level difference Dc(i) in each of the seven three-pixel areas included in the nine-pixel smoothing area Wf(i).

The embodiment is not limited to areas of these sizes; areas of other sizes may be used, the number of gray-level difference calculators being altered as necessary.

The first difference calculator 10a outputs the difference between the maximum and minimum gray levels of the pixels in area Wd(i−3) as gray-level difference data Dd(i−3). Similarly, the second difference calculator 10b to seventh difference calculator 10g calculate the differences between the maximum and minimum gray levels of the pixels in areas Wd(i−2) to Wd(i+3) and output them as gray-level difference data Dd(i−2) to Dd(i+3).

The maximum value selector 11 outputs the largest of the gray-level difference data Dd(i−3) to Dd(i+3) as the maximum gray-level difference data Dc(i). This is the maximum gray-level difference between any pair of pixels separated by a distance of not more than two pixels within the smoothing area Wf(i).

The first to seventh difference calculators 10a to 10g are equipped with means for delaying their inputs by from eight to one dot periods (pixel periods) to obtain output signals for the pixels (i−4) to (i+4) included in the areas Wd(i−3) to Wd(i+3). Specifically, the source data signal Ds is delayed by eight dot periods to obtain the signal of pixel (i−4), by seven dot periods to obtain the signal of pixel (i−3), by six dot periods to obtain the signal of pixel (i−2), by five dot periods to obtain the signal of pixel (i−1), by four dot periods to obtain the signal of pixel (i), by three dot periods to obtain the signal of pixel (i+1), by two dot periods to obtain the signal of pixel (i+2), and by one dot period to obtain the signal of pixel (i+3). The signal of pixel (i+4) is obtained without delaying the source data Ds.

In order to obtain the above delay periods, the first difference calculator 10a to the 10g may be equipped with individual delay circuits, or they may share a single delay circuit with multiple taps.

The maximum gray-level difference Dc(i) calculated for a given pixel (i) is not output from the maximum difference calculator 6 until four dot periods have elapsed from the output of the source data Ds(i) of this pixel by the bit extender 5. Similarly, since the data smoother 7 operates on the nine pixels (i−4) to (i+4) as described above, the smoothed data Df(i) of the pixel (i) are not output from the data smoother 7 until four dot periods have elapsed from the output of the source data Ds(i) of the pixel by the bit extender 5.

To match the timings of the smoothed data and difference data to the timing of the source data Ds, before mixing the data, the data mixer 9 must delay the source data Ds output from the bit extender 5 by four dot periods. The necessary delay circuit (not shown) may be internal to the data mixer 9 or may be located between the bit extender 5 and the data mixer 9. A similar delay circuit (not shown) is present in the following embodiments.

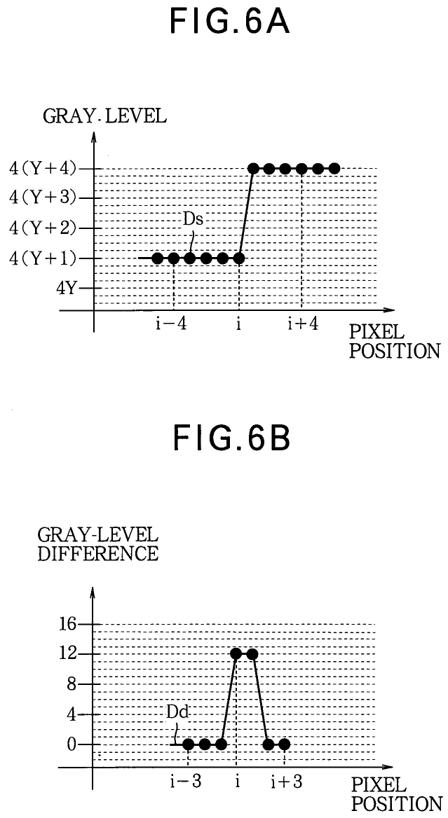

The operation of the maximum difference calculator 6 will be described with reference to a specific example shown in FIGS. 6A and 6B. FIG. 6A shows (n+α)-bit source data Ds, the horizontal and vertical axes representing pixel position and gray level, respectively. FIG. 6B shows the gray-level difference data Dd, the horizontal and vertical axes representing area position (pixel position at the center of each area) and gray-level difference, respectively.

When the maximum difference calculator 6 processes pixel i, the first to seventh difference calculators 10a to 10g calculate the gray-level difference data Dd(i−3) to Dd(i+3) for areas Wd(i−3) to Wd(i+3) as follows.

In areas Wd(i−3), Wd(i−2), and Wd(i−1) the maximum and minimum gray levels are both 4(Y+1), so:

Dd(i−3)=0

Dd(i−2)=0

Dd(i−1)=0

In areas Wd(i) and Wd(i+1), the maximum gray level is 4(Y+4) and the minimum gray level is 4(Y+1), so:

Dd(i)=4(Y+4)−4(Y+1)=12

Dd(i+1)=4(Y+4)−4(Y+1)=12

In areas Wd(i+2), and Wd(i+3) the maximum and minimum gray levels are both 4(Y+4), so

Dd(i+2)=0

Dd(i+3)=0

Since each difference Dd is a difference between the maximum and minimum gray levels in a restricted short-range area such as Wd(i), the first to seventh difference calculators 10a to 10g are able to extract significant pixel-to-pixel variations, such as the change in gray level between pixels i and i+1 in FIG. 6A.

The maximum value selector 11 outputs the largest among the gray-level difference data Dd(i−3) to Dd(i+3) as the maximum gray-level difference Dc(i). In the present example, Dc(i) is equal to Dd(i) (=12) as shown in FIG. 6B.

Since the gray-level difference data are calculated for the individual areas Wd(i−3) to Wd(i+3) in the smoothing area Wf(i), the maximum value selector 11 extracts the size of the maximum short-range change in gray level, rather than the maximum change over the entire smoothing area Wf(i).

FIG. 2E shows the maximum gray-level difference data Dc corresponding to the (n+α)-bit source data in FIG. 2C, in which the maximum gray-level difference data have a value of four at the pixels from j to k, inclusive, and a value of zero at the pixels to the left of pixel j and to the right of pixel k.

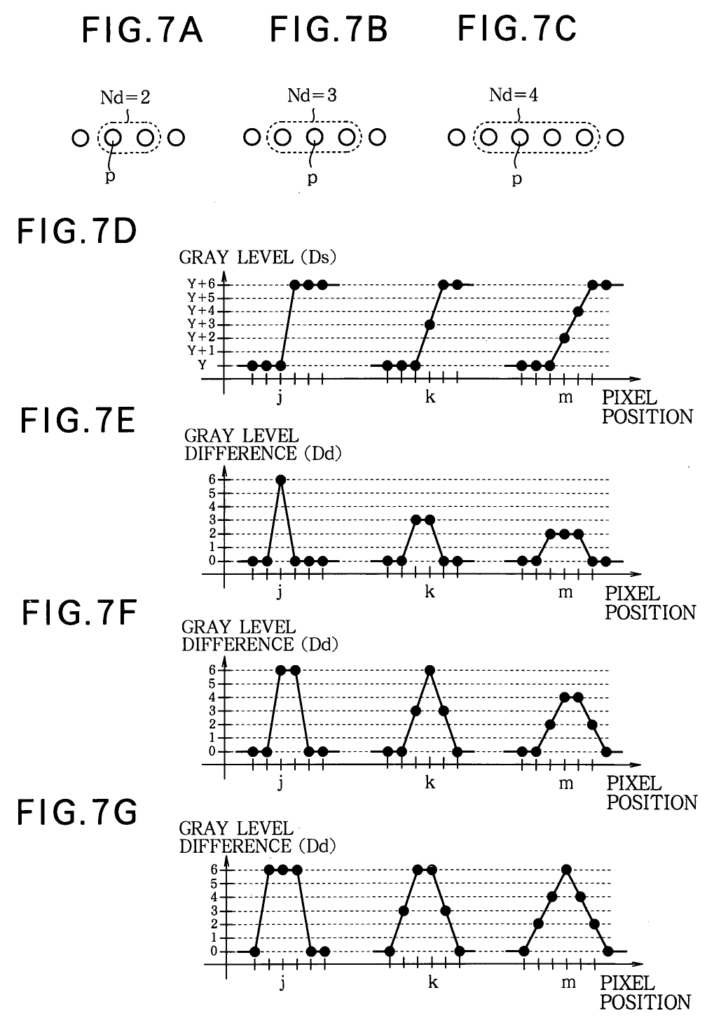

FIGS. 7A to 7G illustrate the dependence of the gray-level difference data on the gray-level difference calculation distance. FIG. 7A shows a gray-level difference calculation area Wd(p) two pixels long (Nd=2) centered on a pixel p; FIG. 7B shows pixel p and area Wd(p) when Nd=3; and FIG. 7C shows pixel p and area Wd(p) when Nd=4. FIG. 7D shows (n+α)-bit source (gray-level) data Ds including three edges with different slopes. The gray-level difference data Dd calculated from the (n+α)-bit source data Ds in FIG. 7D are shown in FIG. 7E for Nd=2, in FIG. 7F for Nd=3, and in FIG. 7G for Nd=4. The horizontal axes in FIGS. 7D to 7G represent pixel position.

At the three edges in the image data Ds shown in FIG. 7D, a change of six gray levels occurs over two pixels from j to j+1, over three pixels from k−1 to k+1, and over four pixels from m−1 to m+2.

When Nd=2 as in FIG. 7A, the gray-level difference is calculated from the two pixels at positions p and p+1. FIG. 7E shows the gray-level difference data Dd calculated for the (n+α)-bit source data shown in FIG. 7D in this case.

At pixel j, for example, pixels j and j+1 are included in the difference calculation area, and the minimum and maximum gray levels are Ds(j)=Y and Ds(j+1)=Y+6, so the gray-level difference is calculated as follows:

Dd(j)=Ds(j+1)−Ds(j)=(Y+6)−Y=6

At pixel k, pixels k and k+1 are included in the difference calculation area, and the minimum and maximum gray levels are Ds(k)=Y+3 and DS(k+1)=Y+6, so the gray-level difference is calculated as follows:

Dd(k)=Ds(k+1)−Ds(k)=(Y+6)−(Y+3)=3

At pixel m, pixels m and m+1 are included in the calculation area, and the minimum and maximum gray levels are DS(m)=Y+2 and DS(m+1)=Y+4, so the gray-level difference is calculated as follows:

Dd(m)=Ds(m+1)−Ds(m)=(Y+4)−(Y+2)=2

When Nd=2, the first to seventh difference calculators 10a to 10g extract the full difference of six gray levels from the edge that changes over the two pixels from j to j+1, but extract only a gray-level difference of three from the edge that changes over the three pixels from k−1 to k+1, and extract only a gray-level difference of two from the edge that changes over the four pixels from m−1 to m+2. Therefore, when Nd=2 is employed to calculate the gray-level difference, it is possible to extract edges that change sharply over ranges of just two pixels.

When Nd=3 as in FIG. 7B, the gray-level difference is calculated from the three pixels from p−1 to p+1. FIG. 7F shows the gray-level difference data Dd calculated for the (n+α)-bit source data shown in FIG. 7D in this case.

At pixel j, for example, the pixels from j−1 to j+1 are included in the difference calculation area, and the minimum and maximum gray levels are Ds(j−1)=Y and Ds(j+1)=Y+6, so the gray-level difference is calculated as follows:

Dd(j)=Ds(j+1)−Ds(j−1)=(Y+6)−Y=6

At pixel k, the pixels from k−1 to k+1 are included in the difference calculation area, and the minimum and maximum gray levels are Ds(k−1)=Y and Ds(k+1)=Y+6, so the gray-level difference is calculated as follows:

Dd(k)=Ds(k+1)−Ds(k−1)=(Y+6)−i Y=6

At pixel m, the pixels from m−1 to m+1 are included in the difference calculation area, and the minimum and maximum gray levels are Ds(m−1)=Y and DS(m+1)=Y+4, so the gray-level difference is calculated as follows:

Dd(m)=Ds(m+1)−Ds(m−1)=(Y+4)−Y=4

When Nd=3, the first to seventh difference calculators 10a to 10g extract the full difference of six gray levels from the edge from j to j+1 and the edge from k−1 to k+1, but extract only a gray-level difference of three from the edge from m−1 to m+2. Therefore, when Nd=3 is employed to calculate the gray-level difference, it is possible to extract edges that change sharply over ranges of two or three pixels.

When Nd=4 as in FIG. 7C, the gray-level difference is calculated from the four pixels from p−1 to p+2. FIG. 7G shows the gray-level difference data Dd calculated for the (n+α)-bit source data shown in FIG. 7D when Nd=4.

At pixel j, for example, the pixels from j−1 to j+2 are included in the calculation area, and the minimum and maximum gray levels are Ds(j−1)=Y and Ds(j+1)=Y+6, so the gray-level difference is calculated as follows:

Dd(j)=Ds(j+1)−Ds(j−1)=(Y+6)−Y=6

At pixel k, the pixels from k−1 to k+2 are included in the calculation area, and the minimum and maximum gray levels are Ds(k−1)=Y and DS(k+1)=Y+6, so the gray-level difference is calculated as follows:

Dd(k)=Ds(k+1)−Ds(k−1)=(Y+6)−Y=6

At pixel m, the pixels from m−1 to m+2 are included in the calculation area, and the minimum and maximum gray levels are Ds(m−1)=Y and DS(m+2)=Y+6, so the gray-level difference is calculated as follows:

Dd(m)=Ds(m+2)−Ds(m−1)=(Y+6)−Y=6

When Nd=4, the first to seventh difference calculators 10a to 10g extract the full difference of six gray levels from all three edges, including the edge from j to j+1, the edge from k−1 to k+1, and the edge from m−1 to m+2. Therefore, when Nd=4 is employed to calculate the gray-level difference, it is possible to extract edges that change sharply over ranges of two, three, and four pixels.

By calculating gray-level differences from a plurality of consecutive pixels, it is thus possible to produce one gray-level difference value that applies to both abruptly changing edges and more gradually changing edges.

The operations for values of Nd from two to four have been illustrated in FIGS. 7A to 7G. The operations for higher values of Nd (e.g., Nd=5) are similar.

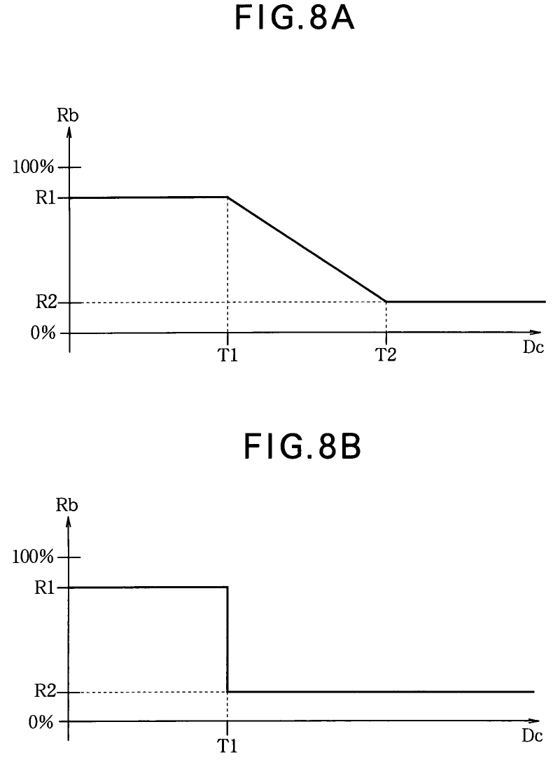

A method of calculating the mixing ratio Rb will now be described with reference to FIGS. 8A and 8B. In FIGS. 8A and 8B, the horizontal axis represents the maximum gray-level difference data Dc and the vertical axis represents the mixing ratio Rb.

The mixing ratio generator 8 preferably converts the maximum gray-level difference data Dc to a mixing ratio Rb according to a conversion curve like the one shown in FIG. 8A. That is, when the maximum gray-level difference data Dc have values less than a first threshold value T1, a first mixing ratio R1 is output; when the maximum gray-level difference data Dc have values greater than a second threshold value T2, a second mixing ratio R2 is output; and when the maximum gray-level difference data Dc have values between the two threshold values T1 and T2, the output mixing ratio varies monotonically from R1 to R2, depending on the value of the maximum gray-level difference data Dc in this range (0≦T1≦T2 and 0≦R2≦R1).

The relationship between the two threshold values T1 and T2 affects the output image data as follows. As an extreme example, if the threshold values are set equal (T1=T2) as shown in FIG. 8B, then in an area in which the maximum gray-level difference value Dc is close to the threshold value T1 (=T2), the mixing ratio may change unpredictably due to the effects of noise etc., and image data mixed according to mixing ratio R1 may alternate irregularly with image data mixed according mixing ratio R2, causing visible erratic flicker on the display.

If two threshold values are set and the mixing ratio is gradually changed between them as shown in FIG. 8A, the sensitivity to the variation of the maximum gray-level difference data Dc decreases, so the occurrence of flicker due to noise and other such effects can be prevented.

In the example shown in FIGS. 2A to 2G, the mixing ratio generator 8 generates a mixing ratio Rb like the one shown in FIG. 2F from the maximum gray-level difference data Dc shown in FIG. 2E, and outputs it to the data mixer 9. If the threshold values T1 and T2 are set to values of six and ten and the mixing ratios R1 and R2 in the conversion curve in FIG. 8A are set to percentage values of one hundred and zero (T1=6, T2=10, R1=100%, R2=0%), then since the values of the maximum gray-level difference data Dc are smaller than threshold value T1 (=6) at all pixels, as shown in FIG. 2E, the mixing ratio Rb at all pixel positions is R1 (=100%), as shown in FIG. 2G.

The data mixer 9 mixes the (n+α)-bit source data Ds with the smoothed data Df according to the mixing ratio Rb shown in FIG. 2F. That is,

Do(i)=(Rb(i)×Df(i)+(100−Rb(i))×Ds(i))/100

Since the mixing ratios corresponding to all the pixel positions are 100% as shown in FIG. 2F, the above equation can be reduced as follows:

Do(i)=(100×Df(i)+(100−100)×Ds(i))/100=Df(i)

That is, the smoothed data Df shown in FIG. 2D are output as the output image data Do in FIG. 2G, so that the number of gray levels of the output image data Do is increased and the gradual change of the original analog signal in FIG. 2A is reproduced.

In other words, when the maximum short-range gray-level difference in a smoothing area is less than a predetermined threshold value, as in FIGS. 2A to 2G, the smoothed data are output directly, adding intermediate gray levels that allow the output image data to change gradually.

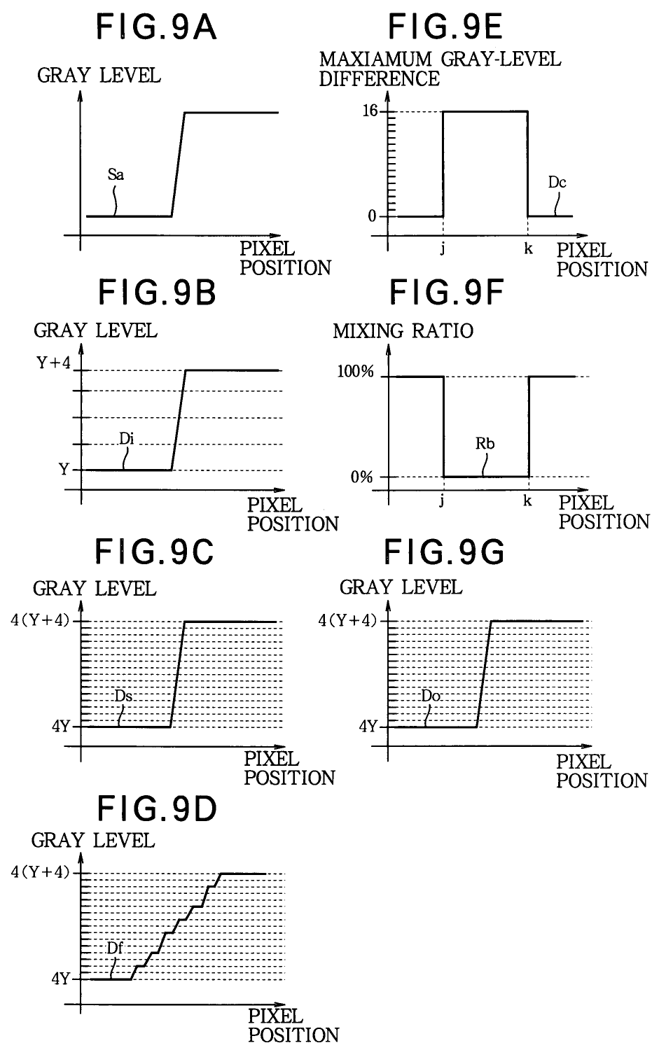

Exemplary signals and data for an input image area with abruptly changing gray levels are shown in FIGS. 9A to 9G. FIG. 9A shows the analog image signal Sa input at the input terminal 1. FIG. 9B shows the corresponding n-bit image data Di. FIG. 9C shows the (n+α)-bit source data Ds output by the bit extender 5 by extending the image data Di by α bits. FIG. 9D shows the smoothed data Df output by the data smoother 7 by smoothing the (n+α)-bit source data Ds. FIG. 9E shows the maximum gray-level difference data Dc generated by the maximum difference calculator 6. FIG. 9F shows the mixing ratio Rb generated by the mixing ratio generator 8. FIG. 9G shows the image data Do output by the data mixer 9. In each of these graphs, the horizontal axis represents pixel position in the vertical or horizontal position. The vertical axis represents an analog gray level in FIG. 9A, a digital gray level in FIGS. 9B, to 9D and FIG. 9G, the maximum gray-level difference in FIG. 9E, and the mixing ratio in FIG. 9F.

The operation of the first embodiment in an image area with an abrupt edge will now be described with reference to FIGS. 9A to 9G and FIG. 1.

The analog image signal Sa shown in FIG. 9A is received by the receiver 2 from the input terminal 1. The receiver 2 converts the analog image signal Sa shown in FIG. 9A to the n-bit digital image data Di shown in FIG. 9B, which are output to the bit extender 5. The image data Di shown in FIG. 9B have gray levels of Y and Y+4.

The bit extender 5 extends the n-bit image data Di shown in FIG. 9B by α bits on the right and outputs (n+α)-bit source data Ds as shown in FIG. 9C. As in FIGS. 2A to 2G, the value of α is two (α=2), so the n-bit image data are extended to (n+2)-bit image data. Since a two-bit extension is equivalent to multiplication by four, the gray levels Y and Y+4 of the image data Di in FIG. 9B are converted to 4Y and 4(Y+4), respectively.

The data smoother 7 smoothes the (n+2)-bit source data Ds shown in FIG. 9C by an LPF process and outputs smoothed data Df as shown in FIG. 9D.

The maximum difference calculator 6 outputs the largest short-range gray-level difference in the smoothing area Wf(i) as the maximum gray-level difference data Dc.

In the example shown in FIGS. 9A to 9G, the maximum gray-level difference data Dc corresponding to the (n+α)-bit source data shown in FIG. 9C are obtained as shown in FIG. 9E: the maximum gray-level difference data have values of sixteen for the pixels from j to k and zero for the pixels to the left of pixel j and to the right of pixel k.

The mixing ratio generator 8 generates the mixing ratio Rb according to the maximum gray-level difference data Dc and outputs it to the data mixer 9.

In the example shown in FIGS. 9A to 9G, the mixing ratio generator 8 generates a mixing ratio like the one shown in FIG. 9F according to the maximum gray-level difference data Dc shown in FIG. 9E and outputs it to the data mixer 9. If the threshold values T1, T2 and the mixing ratios R1, R2 in the conversion curve in FIG. 8A are set as above (T1=6, T2=10, R1=100%, R2=0%), then since the maximum gray-level difference data Dc of the pixels from j to k have values greater than threshold T2 (=10), as shown in FIG. 9E, the mixing ratio Rb of the pixels from j to k is R2 (=0%), as shown in FIG. 2F, and since the maximum gray-level difference data Dc of the pixels to the left of pixel j and to the right of pixel k have values less than threshold T1 (=6), the mixing ratio Rb of the pixels to the left of pixel j and to the right of pixel k is R1 (=100%).

The data mixer 9 mixes the (n+α)-bit source data Ds with the smoothed data Df according to the mixing ratio Rb shown in FIG. 2F. Since the pixels from j to k have a mixing ratio of 0% as shown in FIG. 9F, their output data are calculated as follows:

Do(i)=(0×Df(i)+(100−0)×Ds(i))/100=Ds(i)

Since the pixels to the left of pixel j and to the right of pixel k have a mixing ratio of 100%, their output data are calculated as follows:

Do(i)=(100×Df(i)+(0−0)×Ds(i))/100=Df(i)

Accordingly, the unsmoothed (n+α)-bit source data Ds shown in FIG. 9C are output at the pixels from j to k, and the smoothed data Df shown in FIG. 9D are output at the pixels in the areas to the left of pixel j and to the right of pixel k, resulting in the output image data Do shown in FIG. 9G.

As described above with reference to FIGS. 9A to 9G, if a short-range gray-level difference in a smoothing area is greater than a predetermined threshold value, the source data are output without smoothing, so the sharpness of abrupt edges in the smoothing area can be maintained.

The maximum short-range gray-level differences in the smoothing areas are generated as maximum gray-level difference data, and the source data and the smoothed data are mixed so that as the maximum gray-level difference data decreases, the ratio of the smoothed data to the source data in the output image increases. The number of gray scale levels in the image data can thereby be increased without causing a loss of sharpness in images having, for example, edge areas at which gray levels change abruptly by large amounts, mitigating image degradation due to quantization.

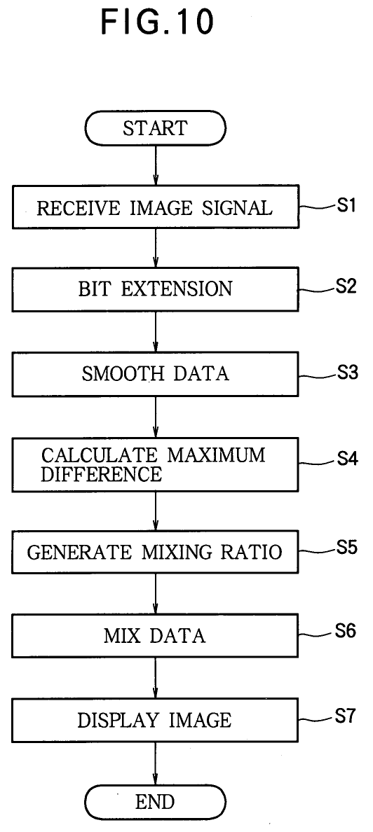

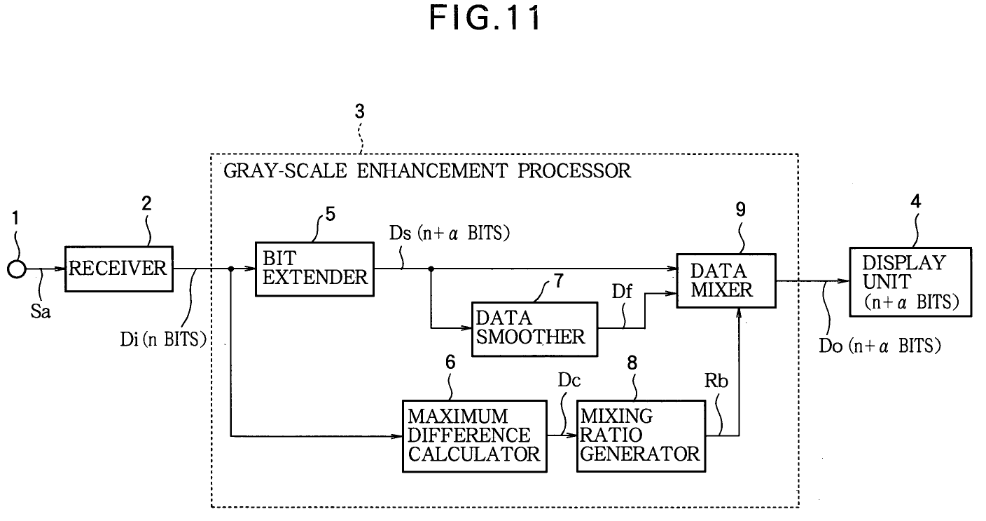

FIG. 10 is a flowchart illustrating the operation of the image display apparatus shown in FIG. 1.

First, an image signal Sa is input at the input terminal 1, and the receiver 2 receives the image signal Sa and outputs n-bit image data Di (S1). The image data Di output by the receiver 2 are input to the bit extender 5 in the gray-scale enhancement processor 3. The bit extender 5 extends the image data Di by α bits on the right and outputs (n+α)-bit image data Ds (S2). The data smoother 7 receives and smoothes the source data Ds by an LPF process and outputs (n+α)-bit smoothed data Df (S3). The maximum difference calculator 6 receives the source data Ds and outputs the largest short-range difference between gray levels in the areas from which the smoothed data Df were calculated as maximum gray-level difference data Dc (S4). The mixing ratio generator 8 receives the maximum gray-level difference data Dc and generates a mixing ratio Rb of the smoothed data Df with respect to the source data Ds so that as the maximum gray-level difference data Dc decrease, the ratio of the smoothed data Df increases (S5). The data mixer 9 receives the source data Ds, the smoothed data Df, and the mixing ratio Rb and generates (n+α)-bit image data Do in which the source data Ds and the smoothed data Df are mixed according to the mixing ratio Rb (S6). The image data Do are input to the display unit 4, which displays an image according to the image data Do (S7).

### Second Embodiment

Referring to FIG. 11, the image display apparatus in the second embodiment is generally similar to the apparatus in the first embodiment shown in FIG. 1. The gray-scale enhancement processor 3 comprises a bit extender 5, a maximum difference calculator 6, a data smoother 7, a mixing ratio generator 8, and a data mixer 9. The maximum difference calculator 6, however, receives the n-bit image data Di output by the receiver 2 instead of the (n+α)-bit source data Ds output by the bit extender 5. In calculating the maximum gray-level difference data, the gray-scale enhancement processor 3 operates as described in the first embodiment except that it operates on n-bit data instead of (n+α)-bit data. This makes it possible to reduce the circuit size of the maximum difference calculator 6 by eliminating the processing of α bits per pixel.

### Third Embodiment

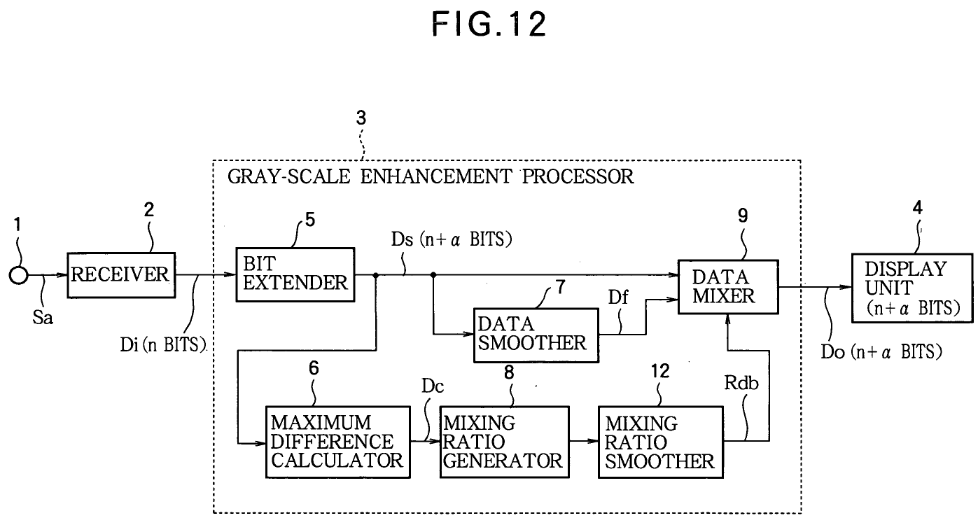

Referring to FIG. 12, the image display apparatus in the third embodiment is generally similar to the apparatus shown in FIG. 1, but the gray-scale enhancement processor 3 includes an additional element. Specifically, the gray-scale enhancement processor 3 now comprises a bit extender 5, a maximum difference calculator 6, a data smoother 7, a mixing ratio generator 8, a data mixer 9, and a mixing ratio smoother 12.

The input terminal 1, receiver 2, display unit 4, bit extender 5, maximum difference calculator 6, data smoother 7, mixing ratio generator 8, and data mixer 9 operate as in the first embodiment, except that the data mixer 9 uses a smoothed mixing ratio output by the mixing ratio smoother 12 instead of the mixing ratio output by the mixing ratio generator 8.

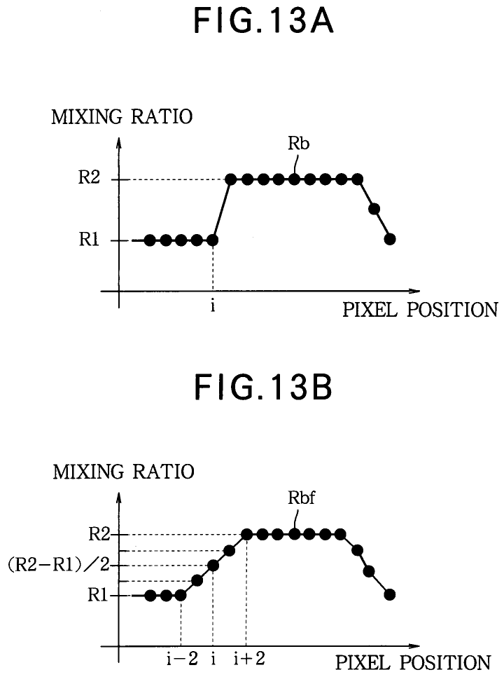

FIGS. 13A and 13B illustrate the operation of the mixing ratio smoother 12. FIG. 13A shows an exemplary mixing ratio data Rb output by the mixing ratio generator 8 to the mixing ration smoother 12. FIG. 13B shows a smoothed mixing ratio Rbf output by the mixing ratio smoother 12.

At pixels i and i+1 in FIG. 13A, the mixing ratio Rb changes abruptly from R1 to R2. If the data mixer 9 were to use the mixing ratio Rb without alteration, such changes could cause image degradation. If the mixing ratios R1 and R2 are set to values of 0% and 100% (R1=0%, R2=100%), for example, output of the source data Ds up to pixel i and the smoothed data Df at the pixels immediately to the right of pixel i might generate a false edge at pixels i and i+1.

The mixing ratio smoother 12 smoothes the mixing ratio Rb by an LPF process to obtain the smoothed mixing ratio Rbf. As one example, the LPF process may smooth the mixing ratios at pixel i and its two adjacent pixels as follows:

Rbf(i−1)=(R2−R1)/4

Rbf(i)=(R2−R1)/2

Rbf(i+1)=3×(R2−R1)/4.

If the mixing ratios R1 and R2 are set to values of 0% and 100% (R1=0%, R2=100%), for example, the smoothed mixing ratios are Rbf(i−1)=25%, Rbf(i)=50%, and Rbf(i+1)=75%. The (n+α)-bit source data Ds are output at the pixels to the left of pixel i−1 and the smoothed data Df are output at the pixels to the right of pixel i+1, but the (n+α)-bit source data Ds and the smoothed data Df are mixed at pixels i−1 to i+1 so that no sharp boundary is visible.

Since the mixing ratio is smoothed, the proportion of smoothed data with respect to the (n+α)-bit source data changes gradually from small to large over a plurality of pixels, concealing the boundary between the source data and the smoothed data, thereby preventing the formation of false edges.

In addition, even if a conversion characteristic with a single threshold value like the one shown in FIG. 8B is used to simplify the mixing ratio generator 8, the mixing ratio smoother 12 prevents this simplification from leading to image degradation.

The smoothing process described above deals with changes in gray level in the horizontal direction, but a similar smoothing of the mixing ratio may be performed in the vertical direction.

### Fourth Embodiment

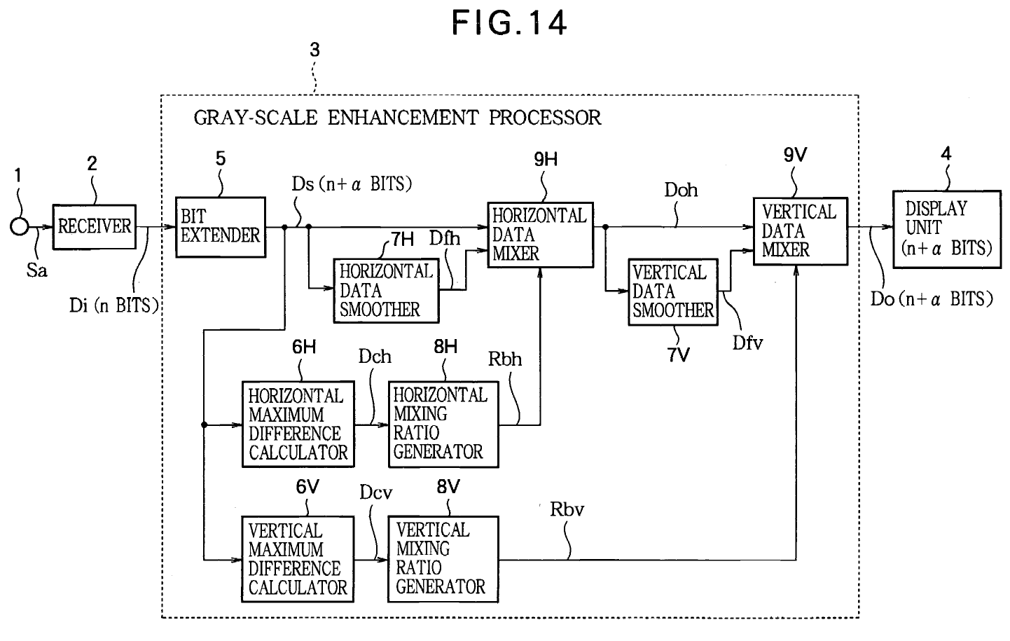

Referring to FIG. 14, the image display apparatus in the forth embodiment is generally similar to the one shown in FIG. 1, but the gray-scale enhancement processor 3 is structured to smooth the source data in both the horizontal and vertical directions. The gray-scale enhancement processor 3 accordingly comprises a bit extender 5, a horizontal maximum difference calculator 6H, a horizontal data smoother 7H, a horizontal mixing ratio generator 8H, a horizontal data mixer 9H, a vertical maximum difference calculator 6V, a vertical data smoother 7V, a vertical mixing ratio generator 8V, and a vertical data mixer 9V.

As in the first embodiment, an analog image signal Sa is input to the receiver 2 and converted to n-bit image data Di. The gray-scale enhancement processor 3 converts the input n-bit image data Di to (n+α)-bit image data Do. The display unit 4 displays the image according to the (n+α)-bit image data Do.

The operation of the fourth embodiment will now be described in more detail with reference to FIG. 14.

The analog image signal Sa is received by the receiver 2 from the input terminal 1. The n-bit image data Di to which the receiver 2 converts the analog image signal Sa are output to the bit extender 5 in the gray-scale enhancement processor 3.

The bit extender 5 extends the image data Di by (α bits on the right and outputs (n+α)-bit source data Ds to the horizontal maximum difference calculator 6H, vertical maximum difference calculator 6V, horizontal data smoother 7H, and horizontal data mixer 9H.

The horizontal data smoother 7H smoothes the (n+α)-bit source data Ds by an LPF process operating in the horizontal direction, and outputs horizontally smoothed data Dfh to the horizontal data mixer 9H.

The horizontal maximum difference calculator 6H outputs the largest short-range difference between gray levels in the (n+α)-bit source data Ds in the horizontal smoothing area around each pixel as maximum horizontal gray-level difference data Dch, which are input to the horizontal mixing ratio generator 8H.

The horizontal mixing ratio generator 8H generates a first mixing ratio Rbh that increases as the maximum horizontal gray-level difference Dch decreases. The first mixing ratio Rbh is a mixing ratio of the horizontally smoothed data Dfh with respect to the (n+α)-bit source data Ds: as Rbh increases, the proportion of horizontally smoothed data Dfh increases. The first mixing ratio Rbh is input to the horizontal data mixer 9H.

The horizontal data mixer 9H mixes the (n+α)-bit source data Ds with the horizontally smoothed data Dfh according to the first mixing ratio Rbh to generate first mixed image data Doh, which are output to the vertical data smoother 7V and vertical data mixer 9V.

The vertical data smoother 7V smoothes the first mixed image data Doh by an LPF process operating in the vertical direction, and outputs vertically smoothed data Dfv to the vertical data mixer 9V.

The vertical maximum difference calculator 6V outputs the largest short-range difference between gray levels in the (n+α)-bit source data Ds in the vertical smoothing area around each pixel as maximum vertical gray-level difference data Dcv, which are input to the vertical mixing ratio generator 8V.

The vertical mixing ratio generator 8V generates a second mixing ratio Rbv that increases as the maximum horizontal gray-level difference Dch decreases. The second mixing ratio Rbv is a mixing ratio of the vertically smoothed data Dfv with respect to the first mixed image data Doh: as Rbv increases, the proportion of vertically smoothed data Dfv increases. The second mixing ratio Rbv is input to the vertical data mixer 9V.

The vertical data mixer 9V mixes the first mixed image data Doh with the vertically smoothed data Dfv according to the second mixing ratio Rbv to generate second mixed image data, which are the data Do output to the display unit 4.

The horizontal data smoother 7H and vertical data smoother 7V both have essentially the same function as the data smoother 7 in FIG. 1. The horizontal data smoother 7H receives the output Ds from the bit extender 5 and operates in the horizontal direction exactly like the data smoother 7 in FIG. 1. The vertical data smoother 7V receives the output Doh from the horizontal data mixer 9H and operates in the same way, except that it operates in the vertical direction.

The horizontal data mixer 9H and vertical data mixer 9V both have essentially the same function as the data mixer 9 in FIG. 1. The horizontal data mixer 9H receives the output Ds from the bit extender 5 and operates in the horizontal direction exactly like the data mixer 9 in FIG. 1. The vertical data mixer 9V receives the output Doh from the horizontal data mixer 9H and operates in the same way, except that it operates in the vertical direction.

The horizontal maximum difference calculator 6H and vertical maximum difference calculator 6V both have essentially the same function as the maximum difference calculator 6 in FIG. 1 and both receive the output Ds from the bit extender 5, as does the maximum difference calculator 6 in FIG. 1. The horizontal maximum difference calculator 6H operates in the horizontal direction while the vertical maximum difference calculator 6V operates in the vertical direction.

The horizontal mixing ratio generator 8H and vertical mixing ratio generator 8V both have essentially the same function as the mixing ratio generator 8 in FIG. 1. The horizontal mixing ratio generator 8H receives the output Dch from the horizontal maximum difference calculator 6H and operates in the horizontal direction, whereas the vertical mixing ratio generator 8V receives the output Dcv from the vertical maximum difference calculator 6V and operates in the vertical direction.

The horizontal maximum difference calculator 6H has the same internal structure as the maximum difference calculator 6 shown in FIG. 5.

The vertical maximum difference calculator 6V also has the internal structure shown in FIG. 5, but the data received as the source data Ds in area Wf(i) are for pixels aligned in the vertical direction; that is, the pixel orientation shown in FIG. 3 is rotated by ninety degrees. The first to seventh difference calculators 10a to 10g in the vertical maximum difference calculator 6V are equipped with means for delaying their inputs by eight to one line periods to obtain the signals of pixels (i−4) to (i+4) included in areas Wd(i−3) to Wd(i+3). More precisely, the source data signal Ds is delayed by eight lines and four dot periods to obtain the signal of pixel (i−4), by seven lines and four dot periods to obtain the signal of pixel (i−3), by six lines and four dot periods to obtain the signal of pixel (i−2), by five lines and four dot periods to obtain the signal of pixel (i−1), by four lines and four dot periods to obtain the signal of pixel (i), by three lines and four dot periods to obtain the signal of pixel (i+1), by two lines and four dot periods to obtain the signal of pixel (i+2), by one line and four dot periods to obtain the signal of pixel (i+3), and by four dot periods to obtain the signal of pixel (i+4).

In order to obtain the above delay periods, the first to seventh gray-level difference calculators (corresponding to the first difference calculator 10a to the 10g) may be equipped with individual delay circuits, or they may share a single delay circuit with multiple taps.

The value Doh of a given pixel (i) is not output from the horizontal data mixer 9H until four dot periods have elapsed from the output of the source data Ds of this pixel by the bit extender 5. The maximum vertical gray-level difference Dcv calculated for this pixel (i) is not output from the vertical maximum difference calculator 6V until four line and four dot periods have elapsed from the output of the source data Ds of this pixel by the bit extender 5. Similarly, since the vertical data smoother 7V operates on the nine pixels (i−4) to (i+4) aligned in the vertical direction as described above, the vertically smoothed data Dfv(i) of the pixel (i) are not output from the vertical data smoother 7V until four line periods have elapsed from the output of the value Doh of the pixel (i) by the horizontal data mixer 9H.

To match the timings of the smoothed data and difference data to the timing of the data Doh, before mixing the data, the vertical data mixer 9V must delay the data Doh output from the horizontal data mixer 9H by four line periods. The necessary delay circuit (not shown) may be internal to the vertical data mixer 9V or may be located between the horizontal data mixer 9H and the vertical data mixer 9V. A similar delay circuit (not shown) is present in some of the following embodiments.

In the above embodiment, the horizontally smoothed data Dfh are mixed before the vertically smoothed data are mixed, but the horizontally smoothed data Dfh may be mixed after the vertically smoothed data have been mixed.

In the fourth embodiment, since the gray scale enhancement process is carried out in both the horizontal and vertical directions, the gray scale can be refined to mitigate quantization effects without causing a loss of sharpness in images having, for example, oblique edges at which the gray level changes abruptly by large amounts in both the horizontal and vertical directions.

### Fifth Embodiment

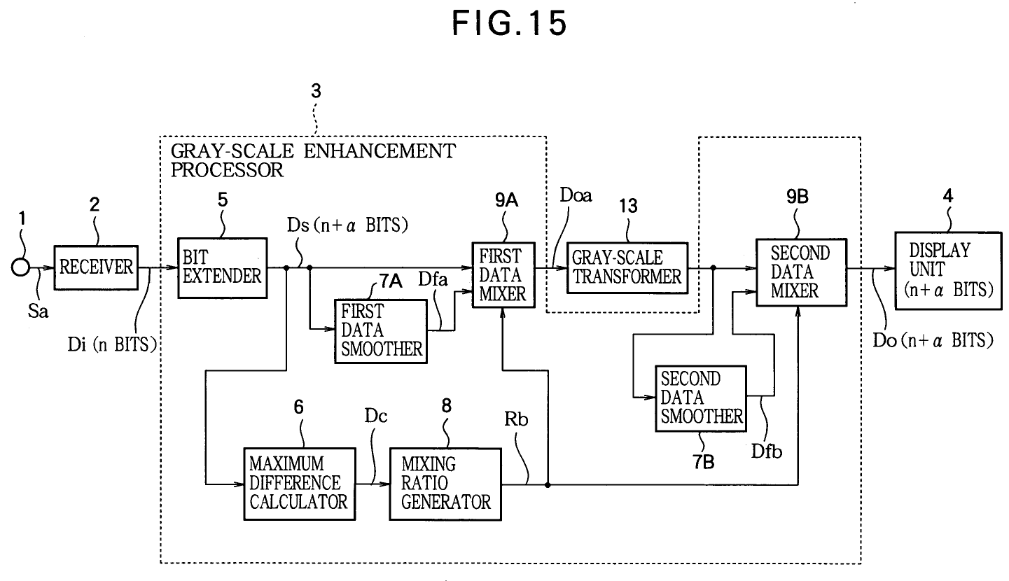

Referring to FIG. 15, the fifth embodiment is an image display apparatus comprising an input terminal 1, a receiver 2, a gray-scale enhancement processor 3, a display unit 4, and a gray-scale transformer 13.

An analog image signal Sa is input from the input terminal 1 to the receiver 2, which converts it to n-bit image data Di, which are output to the gray-scale enhancement processor 3.

The gray-scale enhancement processor 3 comprises a bit extender 5, a maximum difference calculator 6, a first data smoother 7A, a mixing ratio generator 8, a first data mixer 9A, a second data smoother 7B, and a second data mixer 9B. The image data Di are input to the bit extender 5.

The first and second data smoothers 7A, 7B both have the same function as the data smoother 7 in FIG. 1. The first data smoother 7A receives the output Ds from the bit extender 5, as does the data smoother 7 in FIG. 1, whereas the second data smoother 7B receives the output Dj from the gray-scale transformer 13.

The first data mixer 9A and second data mixer 9B both have the same function as the data mixer 9 in FIG. 1, but they perform this function on different inputs. The first data mixer 9A receives the output Ds of the bit extender 5 and the output Dfa of the first data smoother 7A, whereas the second data mixer 9B receives the output Dj of the gray-scale transformer 13 and the output Dfb of the second data smoother 7B.

The mixing ratio Rb determines the mixing proportion of the output Dfa of the first data smoother 7A with respect to the output Ds of the bit extender 5 in the first data mixer 9A and also the mixing proportion of the output Dfb of the second data smoother 7B with respect to the output Dj of the gray-scale transformer 13 in the second data mixer 9B, and is generated by the mixing ratio generator 8 so that as the maximum gray-level difference Dc decreases, the above mixing proportions increase.

The bit extender 5 extends the n-bit image data Di by α bits on the right and outputs the (n+α)-bit image data Ds to the maximum difference calculator 6, first data smoother 7A, and first data mixer 9A. The first data smoother 7A smoothes the (n+α)-bit source data Ds as described in the first embodiment, calculating the smoothed value of each pixel from the source data in an area localized around the pixel, and outputs first smoothed data Dfa to the first data mixer 9A. The maximum difference calculator 6 calculates the largest short-range gray-level difference in the source data Ds in each such localized area, operating as described in the first embodiment, and outputs the resulting maximum gray-level difference data Dc to the mixing ratio generator 8. The mixing ratio generator 8 determines the mixing ratio Rb of each pixel so that the proportions of the smoothed data Dfa, Dfb increase as the maximum gray-level difference Dc decreases, and outputs data describing the mixing ratio Rb to the first and second data mixers 9A, 9B. The first data mixer 9A mixes the (n+α)-bit source data Ds with the first smoothed data Dfa according to the mixing ratio Rb and outputs (n+α)-bit first mixed image data Doa to the gray-scale transformer 13.

The gray-scale transformer 13 performs a gray-scale transformation such as a gamma correction or a contrast correction on the first mixed image data Doa and outputs (n +α)-bit transformed data Dj to the second data smoother 7B and second data mixer 9B. The second data smoother 7B smoothes the transformed data Dj by modifying the transformed value of each pixel on the basis of the transformed data Dj in the above-mentioned area localized around the pixel and outputs second smoothed data Dfb to the second data mixer 9B. The second data mixer 9B mixes the transformed data Dj with the second smoothed data Dfb according to the mixing ratio Rb and outputs the resulting (n+60 )-bit second mixed image data Do to the display unit 4. The display unit 4 displays an image according to the second mixed image data Do.

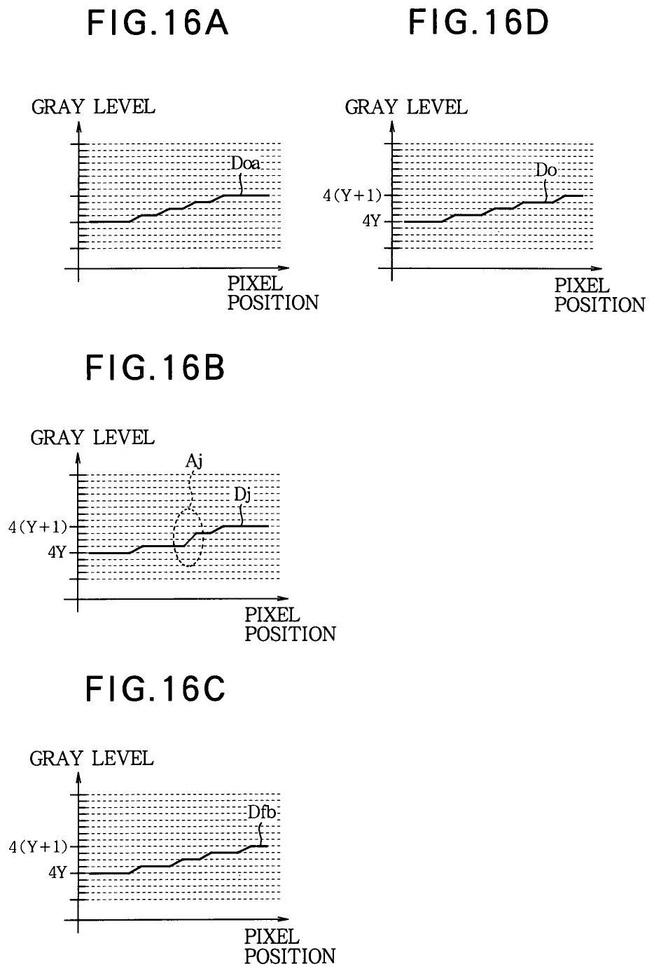

Exemplary signals and data for an input image area with gradually changing gray levels are shown in FIGS. 16A to 16D. FIG. 16A shows the image data Doa output by the first data mixer 9A. FIG. 16B shows the image data Dj obtained when a gray-scale transformation such as a gamma correction or a contrast correction is performed on the image data Doa shown in FIG. 16A. FIG. 16C shows the image data Dfb output by the second data smoother 7B. FIG. 16D shows the image data Do output by the second data mixer 9B. In each of these graphs, the horizontal axis represents pixel position and the vertical axis represents gray level.

The operation of the image display apparatus according to the fifth embodiment will now be described in more detail with reference to FIG. 15 and FIGS. 16A to 16D. The bit extender 5, maximum difference calculator 6, data smoother 7, mixing ratio generator 8, and first data mixer 9A operate in the same manner as the bit extender 5, maximum difference calculator 6, data smoother 7, mixing ratio generator 8, and data mixer 9 in FIG. 1 (except that image data Dfa are obtained in place of the image data Df in FIG. 2D and image data Doa are obtained in place of the image data Do in FIG. 2G). These operations have already been described in the first embodiment, so repeated descriptions will be omitted. Instead, the following description will focus on the operation of the gray-scale transformer 13, second data smoother 7B, and second data mixer 9B, assuming that the image data Do in FIG. 2G have been output as the image data Doa in FIG. 16A.

The image data Doa shown in FIG. 16A are input to the gray-scale transformer 13, which performs a gray-scale transformation such as a gamma correction or a contrast correction and outputs transformed data Dj. As an example, the gray-scale transformer 13 may transform gray level 4Y to 4Y, gray level 4Y+1 to 4Y+1, gray level 4Y+2 to 4Y+1, gray level 4Y+3 to 4Y+3, and gray level 4Y+4 to 4Y+4, transforming the image data Doa in FIG. 16A to the image data Dj shown in FIG. 16B.

As a result of the gray-scale transformation, the gray level 4Y+2 disappears in the image data Dj and a gray-scale jump occurs as shown in area Aj in FIG. 16B. As noted above, such gray-scale jumps can degrade the image by causing visible false edges.

The second data smoother 7B smoothes the transformed data Dj shown in FIG. 16B by an LPF process and outputs the smoothed data Dfb shown in FIG. 16C.

To mix the second smoothed data Dfb with the image data Dj obtained from the gray-scale transformation, the second data mixer 9B uses the mixing ratio Rb generated from the maximum gray-level difference data Dc calculated before the gray-scale transformation.

The reason for using this mixing ratio Rb is as follows. The second data mixer 9B mixes the transformed data Dj with the second smoothed data Dfb. Since the transformed data Dj may include unwanted gray-scale jumps, if the maximum gray-level difference data Dc were to be calculated from the transformed data Dj, these gray-scale jumps would be included in the maximum gray-level difference data Dc, and if as a result the maximum gray-level difference data Dc were to exceed the threshold value T2, the gray-scale jumps would not be smoothed, so that false edges would remain in the image data. Since the maximum gray-level difference data Dc calculated from the source data Ds preceding the gray-scale transformation do not include these unwanted gray-scale jumps, use of the mixing ratio Rb generated from the maximum gray-level difference data Dc calculated before the gray-scale transformation eliminates the unwanted gray-scale jumps.

In the example shown in FIGS. 16A to 16d, the transformed data Dj shown in FIG. 16B and the second smoothed data Dfb shown in FIG. 16C are mixed using the mixing ratio Rb generated in FIG. 2F. That is,

Do(i)=(Rb(i)×Dfb(i)+(100−Rb(i))×Dj(i))/100

Since the mixing ratios corresponding to all the pixel positions are 100% as shown in FIG. 2F, the above equation can be reduced as follows:

Do(i)=(100×Dfb(i)+(100−100)×Dj(i))/100=Dfb(i)

### That is, the smoothed data Dfb in FIG. 16C are output as the output image data Do in FIG. 16D, so that the gray-scale jump shown in FIG. 16B is eliminated.

As described above with reference to FIGS. 16A to 16D, since the image data obtained before the gray-scale transformation do not include unwanted gray-scale jumps, the maximum gray-level difference data calculated from the image data obtained before the gray-scale transformation do not include information derived from unwanted gray-scale jumps. Accordingly, even if the image data obtained from the gray-scale transformation include a gray-scale jump in a region in which the gray levels change gradually, the gray-scale jump can be eliminated because the smoothed data are output.

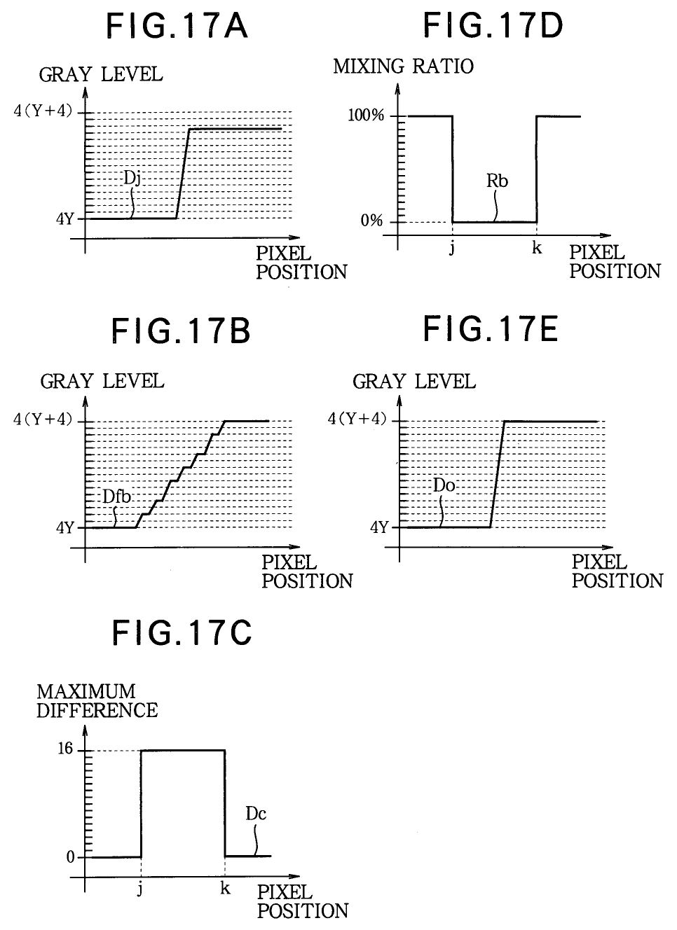

Exemplary signals and data for an input image area with abruptly changing gray levels are shown in FIGS. 17A to 17E. FIG. 17A (comparable to FIG. 16B) shows the data Dj obtained from the gray-scale transformation. FIG. 17B (comparable to FIG. 16C) shows the image data Do output by the second data smoother 7B. FIG. 17C (comparable to FIG. 9E) shows the maximum gray-level difference data Dc generated by the maximum difference calculator 6. FIG. 17D (comparable to FIG. 9F) shows the mixing ratio Rb generated by the mixing ratio generator 8. FIG. 17E (comparable to FIG. 16D) shows the image data Do output by the second data mixer 9B. The operation of the fifth embodiment will also be described in relation to these signals and data.

The bit extender 5, maximum difference calculator 6, data smoother 7, mixing ratio generator 8, and first data mixer 9A operate in the same manner as the bit extender 5, maximum difference calculator 6, data smoother 7, mixing ratio generator 8, and data mixer 9 in the first embodiment (except that, image data Dfa are output in place of the image data Df in FIG. 9D, and image data Doa are output in place of the image data Do in FIG. 9G). These operations have already been described in the first embodiment, so repeated descriptions will again be omitted. Instead, the operations of the gray-scale transformer 13, second data smoother 7B, and second data mixer 9B will be described, now assuming that the image data Do in FIG. 9G have been output as image data Doa.

Image data Doa of the type shown in FIG. 9G are input from the first data mixer 9A to the gray-scale transformer 13. The gray-scale transformer 13 performs a gray-scale transformation such as a gamma correction or a contrast correction and outputs the transformed data Dj. If the gray-scale transformer 13 transforms the gray levels included in the image data Doa as described above (from 4Y to 4Y, from 4Y+1 to 4Y+1, from 4Y+2 to 4Y+1, from 4Y+3 to 4Y+3, and from 4Y+4 to 4Y+4), for example, since the gray levels of the image data Doa in FIG. 9G are transformed from Y to Y and from 4Y+4 to 4Y+4, the image data Doa in FIG. 9G are output without alteration as the transformed data Dj.

The second data smoother 7B smoothes the transformed data Dj shown in FIG. 17A by the LPF process mentioned above and outputs the smoothed data Dfb shown in FIG. 17B.

To mix the second smoothed data Dfb with the image data Dj obtained from the gray-scale transformation, the second data mixer 9B uses the mixing ratio Rb generated from the maximum gray-level difference data Dc calculated before the gray-scale transformation. The transformed data Dj shown in FIG. 17A and the second smoothed data Dfb shown in FIG. 17B are mixed according to the mixing ratio Rb generated in FIG. 17D. Since the pixels from j to k have a mixing ratio of 0% as shown in FIG. 17D, their output data are calculated as follows:

Do(i)=(0×Dfb(i)+(100−0)×Dj(i))/100=Dj(i)

Since the pixels to the left of pixel j and to the right of pixel k have a mixing ratio of 100%, their output data are calculated as follows:

Do(i)=(100×Dfb(i)+(0−0)×Dj(i))/100=Dfb(i)

Accordingly, the transformed data Dj shown in FIG. 17A are output at the pixels from j to k, and the smoothed data Dfb shown in FIG. 17B are output at the pixels in the areas to the left of pixel j and to the right of pixel k, resulting in the output of image data Do with a sharp edge as shown in FIG. 17E.

The value Doa of a given pixel (i) is not output from the first data mixer 9A until four dot periods have elapsed from the output of the source data Ds of the pixel (i) by the bit extender 5.

The vertically smoothed data Dfb(i) of the pixel (i) are not output from the second data smoother 7B until four dot periods have elapsed from the output of the value Doa of the pixel (i) by the first data mixer 9A.

To match the timings of the output data Doa and smoothed data Dfb to the timing of the output Rb, before mixing of the data in the second data mixer 9B, both the output Rb from the mixing ratio generator 8 and the output Doa from the first data mixer 9A must be delayed by four dot periods. The necessary delay circuit is not shown in the drawing. A similar delay circuit (not shown) is also present in the next embodiment.

As described above with reference to FIGS. 17A to 17E, if a short-range gray-level difference in a smoothing area is greater than a predetermined threshold value, the transformed data Dj are output without smoothing, so the sharpness of abrupt edges in the smoothing area can be maintained.

The mixing ratio generated from the maximum gray-level difference data calculated prior to a gray-scale transformation is used to mix the second smoothed data with the image data obtained from the gray-scale transformation. Gray-scale jumps generated in the gray-scale transformer 13 can thereby be eliminated without causing a loss of sharpness in areas in which the gray levels change abruptly by large amounts, mitigating image degradation due to the gray-scale transformation.

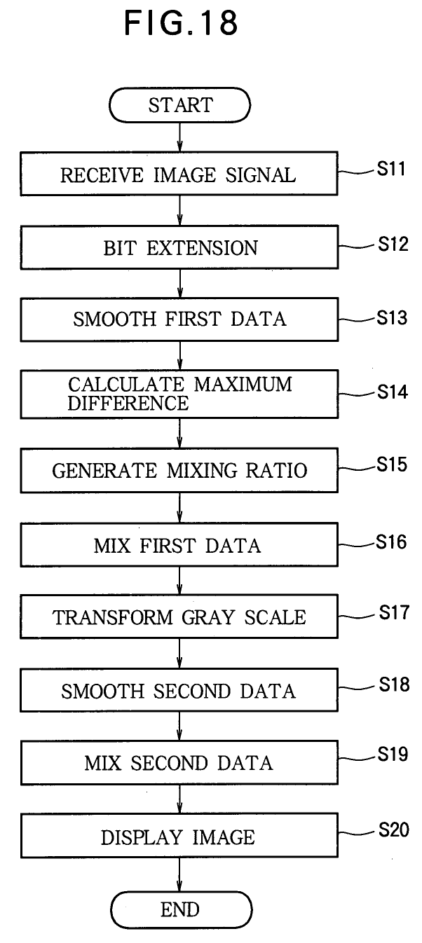

FIG. 18 is a flowchart illustrating the operation of the image display apparatus shown in FIG. 15.

First, an image signal Sa is input at the input terminal 1, and the receiver 2 receives the image signal Sa and outputs n-bit image data Di (S11). The image data Di output by the receiver 2 are input to the bit extender 5 in the gray-scale enhancement processor 3. The bit extender 5 extends the image data Di by α bits on the right and outputs (n+α)-bit image data Ds (S12). The first data smoother 7A receives and smoothes the source data Ds by an LPF process and outputs (n+α)-bit first smoothed data Dfa (S13). The maximum difference calculator 6 receives the source data Ds and outputs the largest short-range difference between gray levels in each area from which the first smoothed data Dfa were calculated as maximum gray-level difference data Dc (S14). The mixing ratio generator 8 receives the maximum gray-level difference data Dc and generates a mixing ratio Rb of the first smoothed data Dfa with respect to the (n+α)-bit source data Ds such that as the maximum gray-level difference Dc decreases, the proportion of the first smoothed data Dfa increases (S15). The first data mixer 9A receives the source data Ds, the first smoothed data Dfa, and the mixing ratio Rb and generates (n+α)-bit image data Doa in which the source data Ds and the first smoothed data Dfa are mixed according to the mixing ratio Rb (S16). The gray-scale transformer 13 performs a gray-scale transformation such as a gamma correction or a contrast correction on the mixed image data Doa and outputs (n+α)-bit transformed data Dj (S17). The second data smoother 7B receives and smoothes the transformed data Dj by an LPF process and outputs (n+α)-bit second smoothed data Dfb (S18). The second data mixer 9B receives the transformed data Dj, the second smoothed data Dfb, and the mixing ratio Rb and generates (n+α)-bit image data Do in which the transformed data Dj and the second smoothed data Dfb are mixed according to the mixing ratio Rb (S19). These image data Do are input to the display unit 4, which displays an image according to the image data Do (S20).

### Sixth Embodiment

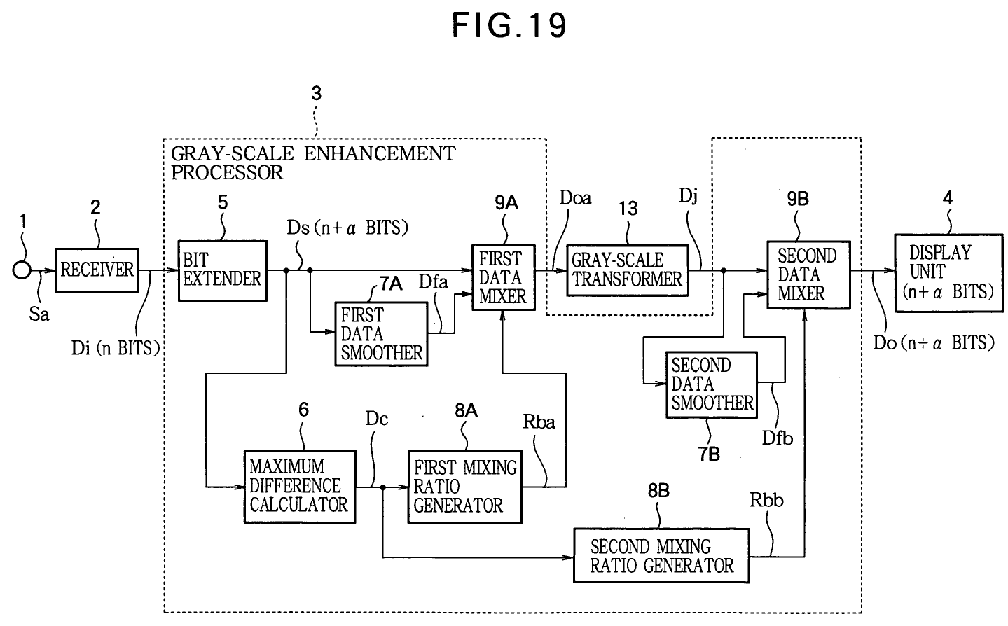

Referring to FIG. 19, the sixth embodiment is an image display apparatus comprising an input terminal 1, a receiver 2, a gray-scale enhancement processor 3, a display unit 4, and a gray-scale transformer 13.

An analog image signal Sa is input from the input terminal 1 to the receiver 2, which converts it to n-bit image data Di, which are output to the gray-scale enhancement processor 3.

The gray-scale enhancement processor 3 comprises a bit extender 5, a maximum difference calculator 6, a first data smoother 7A, a first mixing ratio generator 8A, a first data mixer 9A, a second data smoother 7B, a second mixing ratio generator 8B, and a second data mixer 9B. The image data Di ate input to the bit extender 5. The bit extender 5 extends the n-bit image data Di by α bits on the right and outputs the resulting (n+α)-bit source data Ds to the maximum difference calculator 6, first data smoother 7A, and first data mixer 9A. The first data smoother 7A smoothes the source data Ds on the basis of the source data Ds in an area localized around each pixel and outputs (n+α)-bit first smoothed data Dfa to the first data mixer 9A. The maximum difference calculator 6 calculates the largest short-range difference between gray levels in the source data Ds in the area localized around each pixel, and outputs it to the first and second mixing ratio generators 8A, 8B as maximum gray-level difference data Dc. The first mixing ratio generator 8A determines a first mixing ratio Rba such that the proportion of first smoothed data Dfa with respect to the source data Ds increases as the maximum gray-level difference Dc decreases, and outputs the first mixing ratio Rba to the first data mixer 9A. The first data mixer 9A mixes the source data Ds with the first smoothed data Dfa according to the first mixing ratio Rba and outputs the resulting (n+α)-bit first mixed image data Doa to the gray-scale transformer 13.

The gray-scale transformer 13 performs a gray-scale transformation such as a gamma correction or a contrast correction on the first mixed image data Doa and outputs (n+α)-bit transformed data Dj to the second data smoother 7B and second data mixer 9B. The second data smoother 7B smoothes the transformed data Dj by modifying the value of each pixel on the basis of the transformed data Dj in the above-mentioned area localized around the pixel and outputs (n+α)-bit second smoothed data Dfb to the second data mixer 9B. The second mixing ratio generator 8B determines a second mixing ratio Rbb such that the proportion of the second smoothed data Dfb with respect to the transformed data Dj increases as the maximum gray-level difference Dc decreases, and outputs the second mixing ratio Rbb to the second data mixer 9B. The second data mixer 9B mixes the transformed data Dj with the second smoothed data Dfb according to the second mixing ratio Rbb and outputs the resulting (n+α)-bit second mixed image data Do to the display unit 4. The display unit 4 displays the image according to the second mixed image data Do.

The provision of two mixing ratio generators 8A and 8B enables a separate conversion characteristic like the one shown in FIG. 8A to be defined for each of the two data mixers 9A, 9B, so that the mixing ratios used in the first data mixer 9A and second data mixer 9B can be changed independently. If the mixing ratio R1 is set to a lower value in the second mixing ratio generator 8B than in the first mixing ratio generator 8A, for example, the amount of smoothing of the transformed data Dj can be reduced.

### Seventh Embodiment

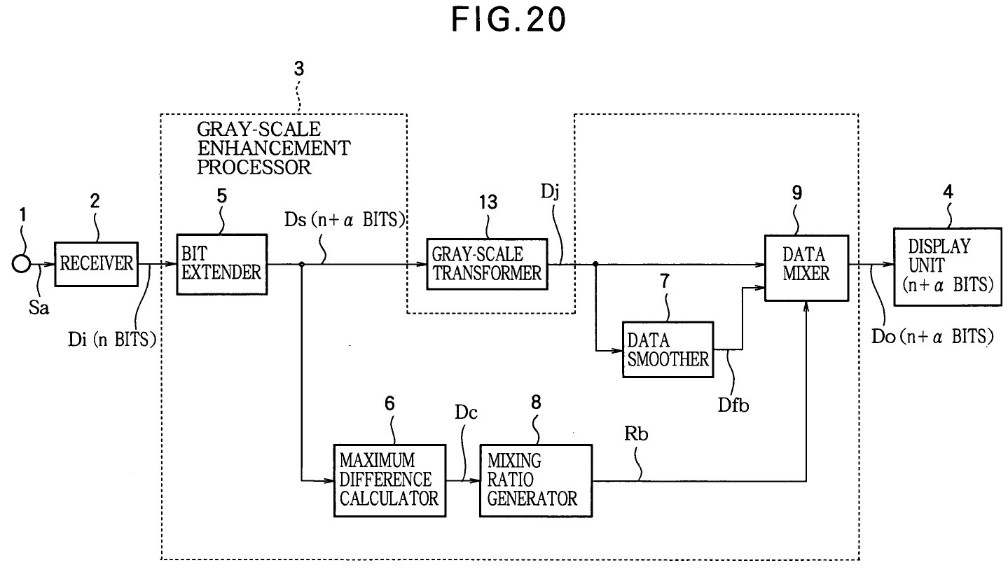

Referring to FIG. 20, the seventh embodiment is an image display apparatus comprising an input terminal 1, a receiver 2, a gray-scale enhancement processor 3, a display unit 4, and a gray-scale transformer 13.

An analog image signal Sa is input from the input terminal 1 to the receiver 2, which converts it to n-bit image data Di, which are output to the gray-scale enhancement processor 3.

The gray-scale enhancement processor 3 comprises a bit extender 5, a maximum difference calculator 6, a data smoother 7, a mixing ratio generator 8, and a data mixer 9. The image data Di are input to the bit extender 5. The bit extender 5 extends the n-bit image data Di by α bits on the right and outputs the resulting (n+α)-bit source data Ds to the maximum difference calculator 6 and gray-scale transformer 13. The maximum difference calculator 6 calculates the largest short-range gray-level difference in the source data Ds in an area localized around each pixel and outputs it to the mixing ratio generator 8 as maximum gray-level difference data Dc. The mixing ratio generator 8 determines a mixing ratio Rb that increases as the maximum gray-level difference Dc decreases, and outputs it to the data mixer 9.

The gray-scale transformer 13 performs a gray-scale transformation such as a gamma correction or a contrast correction on the source data Ds and outputs the transformed data Dj to the data smoother 7 and data mixer 9. The data smoother 7 smoothes the transformed data Dj by modifying the value of each pixel according to the transformed data Dj in the above-mentioned area localized around the pixel, and outputs smoothed data Df to the data mixer 9. The data mixer 9 mixes the transformed data Dj with the smoothed data Df according to the mixing ratio Rb, the proportion of smoothed data increasing as the mixing ratio Rb increases and the maximum difference Dc decreases, and outputs the resulting image data Do to the display unit 4. The display unit 4 displays an image according to the (n+α)-bit image data Do.

By performing the smoothing and mixing processes only after the gray-scale transformation, the seventh embodiment eliminates the circuitry corresponding to the first data smoother 7A and first data mixer 9A in the sixth embodiment shown in FIG. 19. The smoothing and mixing processes performed after the gray-scale transformation both increase the number of gray levels and mitigate image degradation due to the gray-scale transformation.

The processing of gray levels described above deals with changes in gray level in the horizontal direction, but similar processing may be performed in the vertical direction.

### Eighth Embodiment

The eighth embodiment performs processing of gray levels in both the horizontal and vertical directions, as in the fourth embodiment, both before and after a gray-scale transformation.

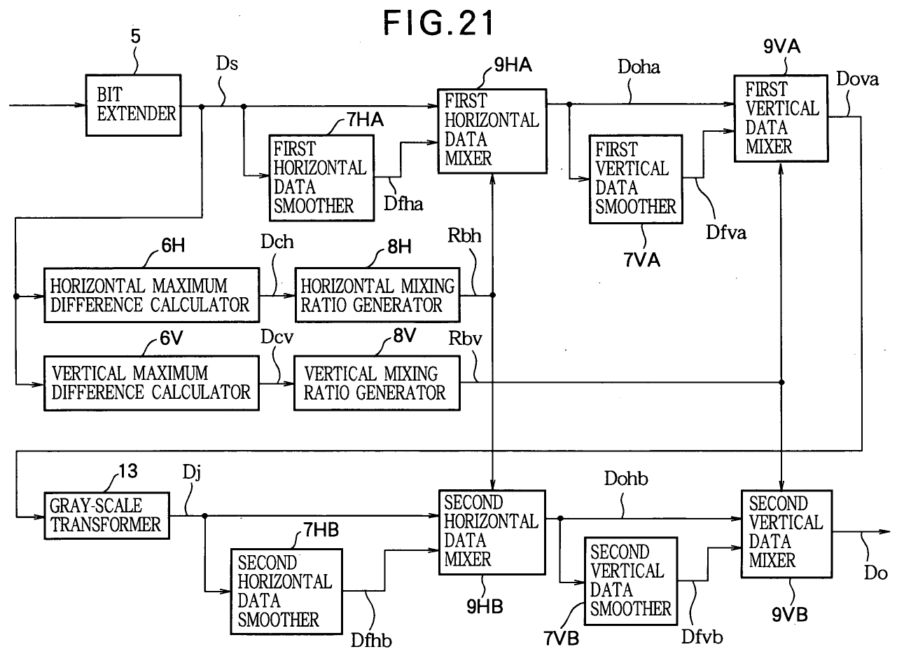

Referring to FIG. 21, the gray-scale enhancement processor 3 in the eighth embodiment comprises a bit extender 5, a first horizontal data smoother 7HA, a horizontal maximum difference calculator 6H, a horizontal mixing ratio generator 8H, a first horizontal data mixer 9HA, a first vertical data smoother 7VA, a vertical maximum difference calculator 6V, a vertical mixing ratio generator 8V, a first vertical data mixer 9VA, a gray-scale transformer 13, a second horizontal data smoother 7HB, a second horizontal data mixer 9HB, a second vertical data smoother 7VB, and a second vertical data mixer 9VB.

The bit extender 5 extends the n-bit input image data Di by α bits on the right and outputs (n+α)-bit source data Ds.

The first horizontal data smoother 7HA smoothes the (n+α)-bit source data Ds in the horizontal direction by modifying the value of each pixel on the basis of the source data in a horizontal area localized around the pixel and outputs first horizontally smoothed data Dfha.

The horizontal maximum difference calculator 6H calculates, for each pixel, the largest short-range difference between gray levels in the (n+α)-bit source data Ds in this horizontal area, and outputs it as maximum horizontal gray-level difference data Dch.

The horizontal mixing ratio generator 8H generates a first mixing ratio Rbh that increases as the maximum horizontal gray-level difference Dch decreases.

The first horizontal data mixer 9HA mixes the (n+α)-bit source data Ds with the first horizontally smoothed data Dfha according to the first mixing ratio Rbh and outputs first mixed image data Doha.

The first vertical data smoother 7VA smoothes the first mixed image data Doha output by the first horizontal data mixer 9HA by modifying the value of each pixel on the basis of the data Doha in a vertical area localized around the pixel and outputs first vertically smoothed data Dfva.

The vertical maximum difference calculator 6V calculates, for each pixel, the largest short-range gray-level difference between the gray levels in the (n+α)-bit source data Ds, the largest short-range difference between gray levels in the (n+α)-bit source data Ds in this vertical area and outputs it as maximum vertical gray-level difference data Dcv.

The vertical mixing ratio generator 8V generates a second mixing ratio Rbv that increases as the maximum vertical gray-level difference Dcv decreases.

The first vertical data mixer 9VA mixes the image data Doha output by the first horizontal data mixer 9HA with the first vertically smoothed data Dfva according to the second mixing ratio Rbv and outputs second mixed image data Dova.

The gray-scale transformer 13 performs a gray-scale transformation on the second mixed image data Dova output by the first vertical data mixer 9VA and outputs the transformed data Dj.

The second horizontal data smoother 7HB smoothes the transformed data Dj by modifying the value of each pixel on the basis of the transformed data Dj in the above-mentioned horizontal area localized around the pixel and outputs second horizontally smoothed data Dfhb.

The second horizontal data mixer 9HB mixes the image data Dj output by the gray-scale transformer 13 with the second horizontally smoothed data Dfhb according to the first mixing ratio Rbh and outputs third mixed image data Dohb.

The second vertical data smoother 7VB smoothes the image data Dohb output by the second horizontal data mixer 9HB in the vertical direction by modifying the value of each pixel on the basis of the third mixed image data Dohb in the above-mentioned vertical area localized around the pixel and outputs second vertically smoothed data Dfvb.

The second vertical data mixer 9VB mixes the third mixed image data Dohb output by the second horizontal data mixer 9HB with the second vertically smoothed data Dfvb according to the second mixing ratio Rbv and outputs fourth mixed image data Do.

The first mixing ratio Rbh determines the mixing proportions of the first horizontally smoothed data Dfha with respect to the source data Ds and of the second horizontally smoothed data Dfhb with respect to the transformed data Dj, causing these proportions to increase as the maximum horizontal gray-level difference Dch decreases.

The second mixing ratio Rbv determines the mixing proportions of the first vertically smoothed data Dfva with respect to the image data Doha output by the first horizontal data mixer 9HA and of the second vertically smoothed data Dfvb with respect to the image data Dohb output by the second horizontal data mixer 9HB, causing these proportions to increase as the maximum vertical gray-level difference Dcv decreases.

### Ninth Embodiment

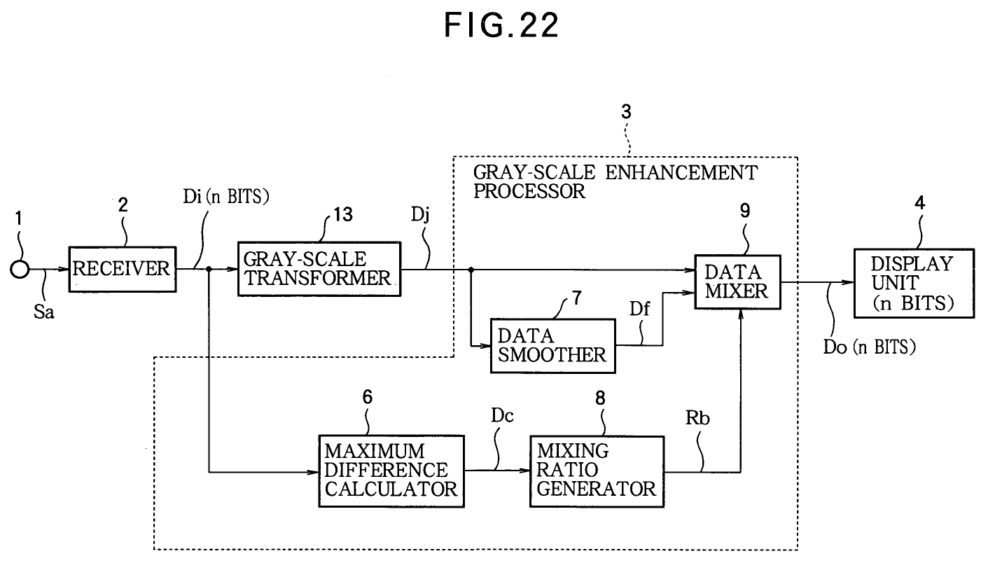

Referring to FIG. 22, the ninth embodiment is an image display apparatus comprising an input terminal 1, a receiver 2, a gray-scale enhancement processor 3, a display unit 4, and a gray-scale transformer 13. An analog image signal Sa is input from the input terminal 1 to the receiver 2, which converts it to n-bit image data Di, which are output to the gray-scale enhancement processor 3 and gray-scale transformer 13. The gray-scale transformer 13 performs a gray-scale transformation such as a gamma correction or a contrast correction and outputs the resulting n-bit image data Dj to the gray-scale enhancement processor 3.

The gray-scale enhancement processor 3 comprises a maximum difference calculator 6, a data smoother 7, a mixing ratio generator 8, and a data mixer 9. The image data Di are input to the maximum difference calculator 6 and the transformed image data Dj are input to the data smoother 7 and data mixer 9. The data smoother 7 smoothes the transformed data Dj by modifying the value of each pixel on the basis of the data Dj in an area localized around the pixel and outputs the smoothed data Df to the data mixer 9. The maximum difference calculator 6 calculates, for each pixel, the largest short-range difference between gray levels in the image data Di in this localized area and outputs it to the mixing ratio generator 8 as maximum gray-level difference data Dc. The mixing ratio generator 8 determines a mixing ratio Rb of the smoothed data Df with respect to the transformed data Dj such that the proportion of the smoothed data Df increases as the maximum gray-level difference Dc decreases, and outputs the mixing ratio Rb to the data mixer 9. The data mixer 9 mixes the transformed data Dj with the smoothed data Df according to the mixing ratio Rb and outputs the n-bit mixed image data Do to the display unit 4. The display unit 4 displays the image according to the n-bit mixed image data Do.

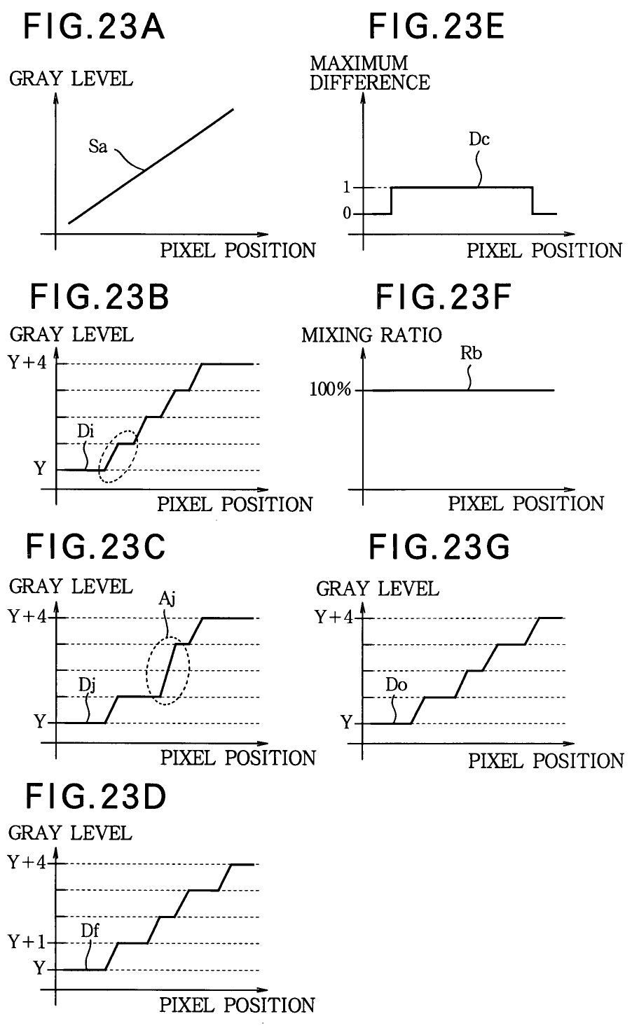

Exemplary signals and data for an input image area with gradually changing gray levels are shown in FIGS. 23A to 23G. FIG. 23A shows the analog image signal Sa input at the input terminal 1. FIG. 23B shows the corresponding n-bit image data Di. FIG. 23C shows the image data Dj obtained from a gamma correction, contrast correction, or other gray-scale transformation performed on the image data Di shown in FIG. 23B. FIG. 23D shows the image data Df output by the data smoother 7. FIG. 23E shows the maximum gray-level difference data Dc output by the maximum difference calculator 6. FIG. 23F shows the mixing ratio Rb output by the mixing ratio generator 8. FIG. 23G shows the image data Do output by the data mixer 9. In each of these graphs, the horizontal axis represents pixel position. The vertical axis represents analog gray level in FIG. 23A, digital gray level in FIGS. 23B to 23D and FIG. 23G, the maximum gray-level difference in FIG. 23E, and the mixing ratio in FIG. 23F.

The operation of the ninth embodiment will now be described in detail with reference to FIG. 22 and FIGS. 23A to 23G.

The analog image signal Sa shown in FIG. 23A is received by the receiver 2 from the input terminal 1. The receiver 2 converts the analog image signal Sa shown in FIG. 23A to the n-bit image data Di shown in FIG. 23B, which are output to the maximum difference calculator 6 and gray-scale transformer 13.

The gray-scale transformer 13 performs a gray-scale transformation such as a gamma correction or a contrast correction on the image data Di and outputs transformed data Dj. As an example, the gray-scale transformer 13 may transform gray level Y to Y, gray level Y+1 to Y+1, gray level Y+2 to Y+1, gray level Y+3 to Y+3, and gray level Y+4 to Y+4, transforming the image data Di in FIG. 23B to the image data Dj shown in FIG. 23C.

As a result of the gray-scale transformation, the gray level Y+2 disappears in the transformed image data Dj and a gray-scale jump occurs as shown in area Aj in FIG. 23C. As noted above, such gray-scale jumps can produce visible false edges, causing image degradation.

The data smoother 7 smoothes the transformed image data Dj shown in FIG. 23C by an LPF process and outputs the smoothed data Df shown in FIG. 23D.

As described above, the maximum difference calculator 6 calculates, from the input image data Di, the largest short-range difference between gray levels in each area from which the smoothed data Df are calculated and outputs it to, the mixing ratio generator 8 as a maximum gray-level difference Dc. The maximum gray-level difference data Dc calculated according to the data shown in FIG. 23B are obtained as shown in FIG. 23E. The operation of the maximum difference calculator 6 has already been described in the first embodiment, so a repeated description will be omitted.

The reason for using the mixing ratio Rb calculated from the image data Di is as follows. The data mixer 9 mixes the transformed data Dj obtained from the gray-scale transformation with the smoothed data Df obtained by smoothing the transformed data Dj. Since the transformed data Dj include gray-scale jumps, if the maximum gray-level difference data Dc were to be calculated from the transformed data Dj, the gray-scale jumps would be included in the maximum gray-level difference data Dc, and if as a result the maximum gray-level difference data Dc were to exceed the threshold value T2, the gray-scale jumps would not be smoothed, so that false edges would remain in the image data. Since the maximum gray-level difference data Dc calculated from the image data Di obtained before the gray-scale transformation do not include the gray-scale jumps generated by the gray-scale transformation, use of the mixing ratio Rb generated from the maximum gray-level difference data Dc calculated before the gray-scale transformation eliminates these unwanted gray-scale jumps.

The mixing ratio generator 8 generates a mixing ratio Rb like the one shown in FIG. 23F from the maximum gray-level difference data Dc shown in FIG. 23E, and outputs it to the data mixer 9. If the threshold values T1 and T2 are set to values of two and three and the mixing ratios R1 and R2 in the conversion curve in FIG. 8A are set to percentage values of one hundred and zero (T1=2, T2=3, R1=100%, R2=0%), since the values of the maximum gray-level difference data Dc are smaller than threshold value T1 (=2) at all pixels, as shown in FIG. 23E, the mixing ratio Rb at all pixel positions is R1 (=100%), as shown in FIG. 23F.

The data mixer 9 mixes the transformed data Dj with the smoothed data Df according to the mixing ratio Rb shown in FIG. 23F. That is,

Do(i)=(Rb(i)×Df(i)+(100−Rb(i))×Dj(i))/100

Since the mixing ratios at all the pixel positions are 100% as shown in FIG. 23F, the above equation can be reduced as follows:

Do(i)=(100×Df(i)+(100−100)×Dj(i))/100=Df(i)

### That is, the smoothed data Df shown in FIG. 23D are output as the output image data Do in FIG. 23G.

As described above with reference to FIGS. 23A to 23G, since the image data obtained before the gray-scale transformation do not include unwanted gray-scale jumps, the maximum gray-level difference data calculated from the image data obtained before the gray-scale transformation do not include unwanted gray-scale jump information. Accordingly, even if the image data obtained from the gray-scale transformation include a gray-scale jump in a region in which the gray levels should change gradually, the gray-scale jump is eliminated because the smoothed data are output.

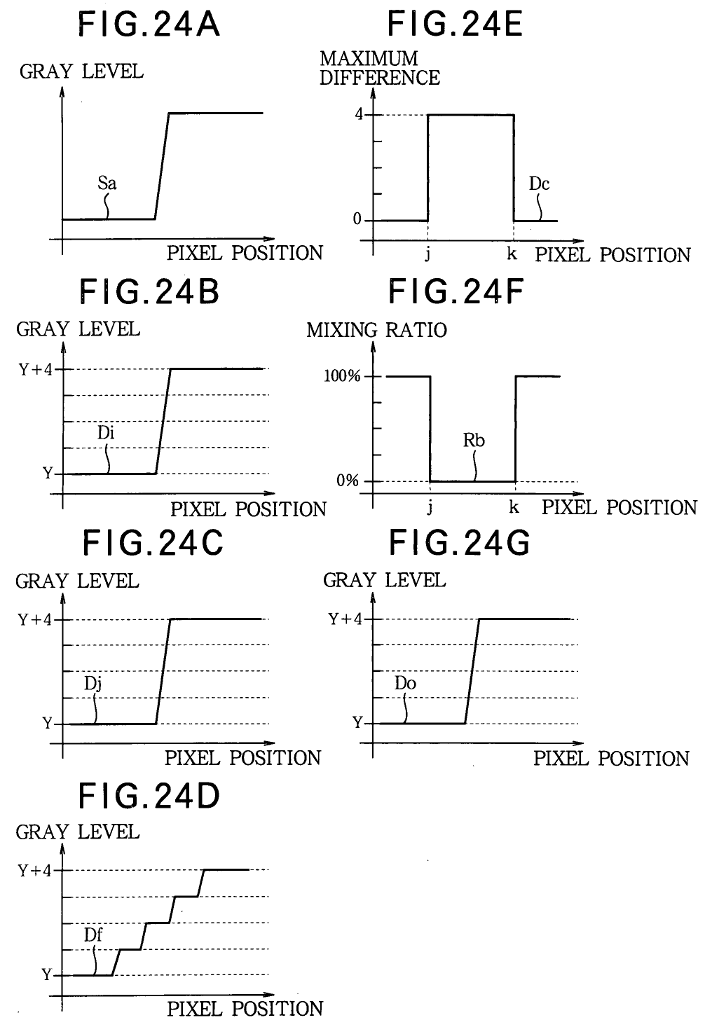

Exemplary signals and data for an input image area with abruptly changing gray levels are shown in FIGS. 24A to 24G. FIG. 24A shows the analog image signal Sa input at the input terminal 1. FIG. 24B shows the corresponding n-bit image data Di. FIG. 24C shows the image data Dj obtained after a gray-scale transformation such as a gamma correction or contrast correction is performed on the image data Di shown in FIG. 24B. FIG. 24D shows the image data Df output by the data smoother 7. FIG. 24E shows the maximum gray-level difference data Dc output by the maximum difference calculator 6. FIG. 24F shows the mixing ratio Rb output by the mixing ratio generator 8. FIG. 24G shows the image data Do output by the data mixer 9. In each of these graphs, the horizontal axis represents pixel position. The vertical axis represents analog gray level in FIG. 24A, digital gray level in FIGS. 24B to 24D and FIG. 24G, the maximum gray-level difference in FIG. 24E, and the mixing ratio in FIG. 24F.

The operation of the ninth embodiment will now be described in detail with reference to FIG. 22 and FIGS. 24A to 24G.

The analog image signal Sa shown in FIG. 24A is received by the receiver 2 from the input terminal 1. The receiver 2 converts the analog image signal Sa shown in FIG. 24A to the n-bit image data Di shown in FIG. 24B, which are output to the maximum difference calculator 6 and gray-scale transformer 13.

The gray-scale transformer 13 performs a gray-scale transformation such as a gamma correction, a contrast correction, or the like on the image data Di and outputs transformed data Dj. As an example, the gray-scale transformer 13 may transform gray level Y to Y, gray level Y+1 to Y+1, gray level Y+2 to Y+1, gray level Y+3 to Y+3, and gray level Y+4 to Y+4, transforming the image data Di in FIG. 24B to the image data Dj shown in FIG. 24C.

The data smoother 7 smoothes the transformed data Dj shown in FIG. 24C by an LPF process and outputs the smoothed data Df shown in FIG. 24D.

As described above, the maximum difference calculator 6 calculates, from the input image data Di, the largest short-range difference between gray levels in each area from which the smoothed data Df are calculated and outputs it to the mixing ratio generator 8 as maximum gray-level difference data Dc. The maximum gray-level difference data Dc corresponding to the image data Di shown in FIG. 24B are obtained as shown in FIG. 24E: the maximum gray-level difference data have values of four for the pixels from j to k, inclusive, and zero for the pixels to the left of pixel j and to the right of pixel k.

The mixing ratio generator 8 generates a mixing ratio like the one shown in FIG. 24F according to the maximum gray-level difference data Dc shown in FIG. 24E and outputs it to the data mixer 9. If the threshold values T1, T2 and the mixing ratios R1, R2 in the conversion curve in FIG. 8A are set as before (T1=2, T2=3, R1=100%, R2=0%), then since the maximum gray-level difference data Dc of the pixels from j to k have values greater than threshold T2 (=3), as shown in FIG. 24E, the mixing ratio Rb of the pixels from j to k is R2 (=0%), as shown in FIG. 24F, and since the maximum gray-level difference data Dc of the pixels to the left of pixel j and to the right of pixel k have values less than threshold T1 (=2), the mixing ratio Rb of the pixels to the left of pixel j and to the right of pixel k is R1 (=100%).

The data mixer 9 mixes the transformed data Dj with the smoothed data Df according to the mixing ratio Rb shown in FIG. 24F. Since the pixels from j to k have a mixing ratio of 0% as shown in FIG. 24F, their output data are calculated as follows:

Do(i)=(0×Df(i)+(100−0)×Dj(i))/100=Dj(i)

Since the pixels to the left of pixel j and to the right of pixel k have a mixing ratio of 100%, their output data are calculated as follows:

Do(i)=(100×Df(i)+(100−100)×Dj(i))/100=Df(i)

Accordingly, the unsmoothed data Dj shown in FIG. 24C are output at the pixels from j to k, and the smoothed data Df shown in FIG. 24D are output at the pixels in the areas to the left of pixel j and to the right of pixel k, resulting in the output image data Do shown in FIG. 24G.

As described above with reference to FIGS. 24A to 24G, if a short-range gray-level difference in a smoothing area is greater than a predetermined threshold value, the transformed data Dj are output without smoothing, so the sharpness of abrupt edges in the smoothing area can be maintained.

The mixing ratio generated from the maximum gray-level difference data calculated prior to the gray-scale transformation is used to mix the transformed data with the smoothed transformed data. Gray-scale jumps generated in the gray-scale transformer 13 can thereby be eliminated, mitigating image degradation due to the gray-scale transformation, without causing a loss of edge sharpness.

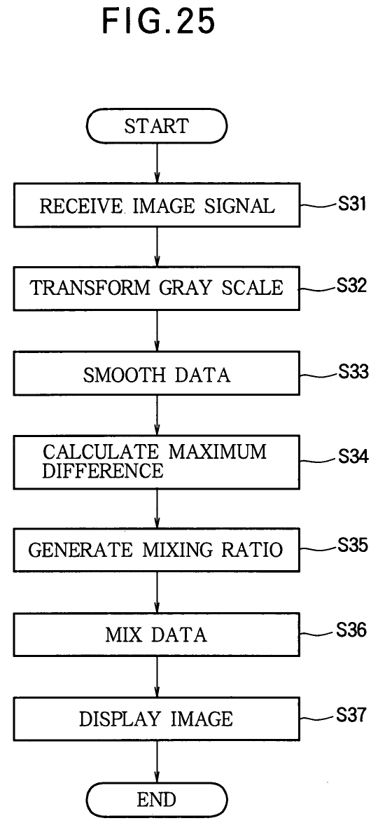

FIG. 25 is a flowchart illustrating the operation of the image display apparatus shown in FIG. 22.

First, an image signal Sa is input at the input terminal 1, and the receiver 2 receives the image signal Sa and outputs n-bit image data Di (S31). The gray-scale transformer 13 receives the image data Di, performs a gray-scale transformation such as a gamma correction or contrast correction, and outputs n-bit transformed data Dj (S32). The data smoother 7 receives and smoothes the transformed data Dj by an LPF process and outputs the smoothed data Df (S33). The maximum difference calculator 6 receives the n-bit image data Di and outputs the largest short-range difference between the gray levels in each smoothing area of the smoothed data Df as maximum gray-level difference data Dc (S34). The mixing ratio generator 8 receives the maximum gray-level difference data Dc and generates a mixing ratio Rb of the smoothed data Df with respect to the transformed data Dj such that as the maximum gray-level difference data Dc decrease, the proportion of the smoothed data Df with increases (S35). The data mixer 9 receives the transformed data Dj, the smoothed data Df, and the mixing ratio Rb and generates image data Do in which the transformed data Dj and the smoothed data Df are mixed according to the mixing ratio Rb (S36). These image data Do are input to the display unit 4, which displays an image according to the image data Do (S37).

### Tenth Embodiment

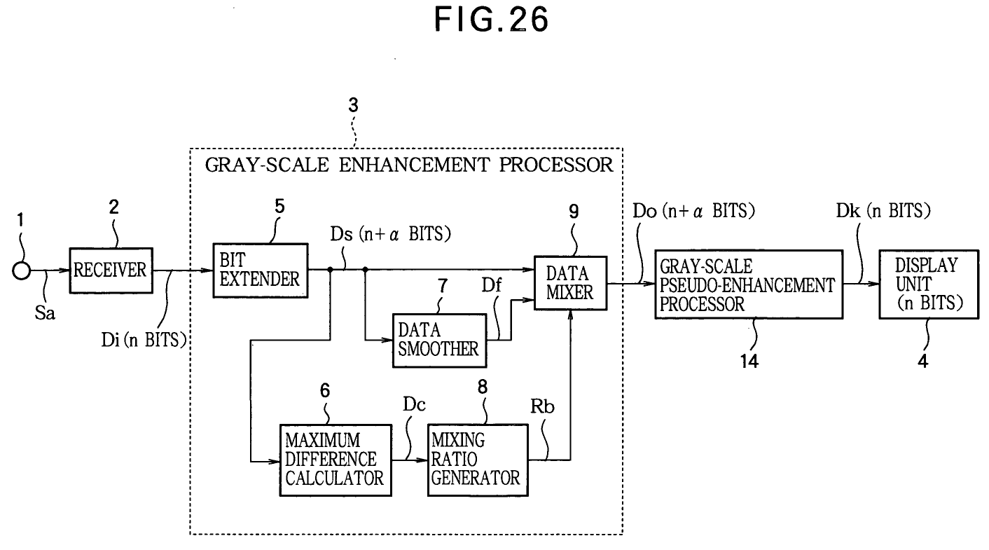

Referring to FIG. 26, the tenth embodiment is an image display apparatus comprising an input terminal 1, a receiver 2, a gray-scale enhancement processor 3, a display unit 4, and a gray-scale pseudo-enhancement processor 14.

An analog image signal Sa is input from the input terminal 1 to the receiver 2, which converts it to n-bit image data Di, which are output to the gray-scale enhancement processor 3.

The gray-scale enhancement processor 3, which comprises a bit extender 5, a maximum difference calculator 6, a data smoother 7, a mixing ratio generator 8, and a data mixer 9, converts the received n-bit image data Di to (n+α)-bit image data Do, which are output to the gray-scale pseudo-enhancement processor 14. The gray-scale pseudo-enhancement processor 14 down-converts the (n+α)-bit mixed image data Do to n-bit output image data Dk by a known process such as error diffusion or dithering that represents lost gray levels as distributions of output gray levels, and outputs the n-bit image data Dk to the display unit 4. The display unit 4 displays the image according to the n-bit image data Dk.

The operation of the gray-scale enhancement processor 3 has already been described in the first embodiment, so a repeated description will be omitted. The operation of the gray-scale pseudo-enhancement processor 14 when an error diffusion process is used will be described below.

In an error diffusion process, quantization error is added to neighboring pixels, thereby distributing lost gray scale information onto those pixels. For example, the quantization error E(x, y) at coordinate position (x, y) may be distributed onto the three neighboring pixels at positions (x+1, y), (x, y+1), and (x+1, y+1), converting their data values from D to De as follows:

De(x+1, y)=D(x+1, y)+3×E(x, y)/8

De(x, y+1)=D(x, y+1)+3×E(x, y)/8

De(x+1, y+1)=D(x+1, y+1)+2×E(x, y)/8

When the (n+α)-bit image data Do are converted back to n-bit image data Dk, error diffusion or dithering enables the intermediate gray levels that were generated by the gray-scale enhancement processor 3 to be represented in the n-bit image data Dk. Images with an (n+α)-bit gray scale can thereby be displayed even by a receiver that outputs n-bit image data and a display that can only display n-bit gray levels.

Applications of the present invention include image display apparatus such as, for example, liquid crystal television sets and plasma television sets.

The invention is applicable in both color and monochrome display apparatus. In a color display, the invention may be applied to each color separately, or to the luminance component of an image signal expressed in terms of luminance and chrominance.

The α bits appended by the bit extenders in the preceding embodiments need not be all zero bits. They may have any fixed values.

The invention may be practiced in either hardware or software, or a combination of hardware and software.

Those skilled in the art will recognize that further variations are possible within the scope of the invention, which is defined in the appended claims.

What is claimed is:

1. An image processing method comprising:
extending n-bit input image data by α bits to generate source data having n+α bits per pixel, where n and α are positive integers;
modifying the source data of each pixel according to the source data in an area localized around the pixel to generate smoothed data;
calculating a maximum difference between gray levels of the source data in said area;
generating a mixing ratio of the smoothed data with respect to the source data, the mixing ratio increasing as said maximum difference decreases; and
mixing the smoothed data and the source data according to the mixing ratio to generate and output mixed image data.

2. The image processing method of claim 1, wherein the maximum difference is a maximum difference between pixels separated by not more than a predetermined distance within said area.

3. An image processing apparatus comprising:
a bit extender for extending n-bit input image data by α bits to generate source data having n+α bits per pixel, where n and α are positive integers;
a first data smoother for modifying the source data of each pixel according to the source data in a first area localized around the pixel to generate first smoothed data;
a first maximum difference calculator for calculating a first maximum difference between gray levels of the source data in the first area;
a first mixing ratio generator for generating a first mixing ratio, the first mixing ratio increasing as the first maximum difference decreases; and
a first data mixer for mixing the first smoothed data and the source data according to the first mixing ratio to generate and output first mixed image data, the mixing proportion of the first smoothed data increasing as the first mixing ratio increases.

4. The image processing apparatus of claim 3, wherein the first maximum difference is a maximum difference between pixels separated by not more than a first predetermined distance within the first area.

5. The image processing apparatus of claim 3, wherein the first mixing ratio generator:
sets the first mixing ratio to a first value if the first maximum difference is less than a first threshold;
sets the first mixing ratio to a second value if the first maximum difference is greater than a second threshold, the second value being less than the first value, the second threshold being greater than the first threshold; and
sets the first mixing ratio to a value that decreases monotonically from the first value to the second value as the first maximum difference varies from the first threshold to the second threshold.

6. The image processing apparatus of claim 3, wherein the first mixing ratio generator:
sets the first mixing ratio to a first value if the first maximum difference is less than a threshold; and
sets the first mixing ratio to a second value if the first maximum difference is greater than the threshold, the second value being less than the first value.

7. The image processing apparatus of claim 3, further comprising a mixing ratio smoother for smoothing the first mixing ratio and outputting a smoothed first mixing ratio, wherein the data mixer mixes the first smoothed data and the source data according to the smoothed first mixing ratio.

8. The image processing apparatus of claim 3, wherein the first maximum difference calculator calculates the first maximum difference from the n-bit input image data.

9. The image processing apparatus of claim 3, wherein the first area is a linear area extending in a first direction around said pixel, the image processing apparatus further comprising:
a second data smoother for modifying the first mixed image data of said each pixel according to the first mixed image data in a second area localized around the pixel to generate second smoothed data, the second area being a linear area extending in a second direction orthogonal to the first direction;
a second maximum difference calculator for calculating a second maximum difference between gray levels of the source data in the second area;
a second mixing ratio generator for generating a second mixing ratio, the second mixing ratio increasing as the second maximum vertical difference decreases; and
a second data mixer for mixing the first mixed image data and the second smoothed data according to the second mixing ratio to generate and output second mixed image data, the mixing proportion of the second smoothed data increasing as the second mixing ratio increases.

10. The image processing apparatus of claim 9, wherein the second maximum difference is a maximum difference between pixels separated by not more than a second predetermined distance within the second area.

11. The image processing method of claim 1, further comprising:
transforming the gray scale of the mixed image data to generate transformed data;
modifying the transformed value of said each pixel according to the transformed data in said area localized around the pixel to generate smoothed transformed data; and
mixing the smoothed transformed data and the transformed data according to the first mixing ratio to generate output image data; wherein
as the mixing ratio increases, the mixing proportion of the smoothed transformed data with respect to the transformed data increases.

12. The image processing apparatus of claim 3, further comprising:
a gray-scale transformer for transforming a gray scale of the first mixed image data to generate transformed data;
a second data smoother for modifying the transformed data of said each pixel according to the transformed data in the first area to generate second smoothed data; and
a second data mixer for mixing the transformed data and the second smoothed data according to the first mixing ratio to generate and output second mixed image data, the mixing proportion of the second smoothed data increasing as the first mixing ratio increases.

13. The image processing apparatus of claim 3, further comprising:
a gray-scale transformer for transforming a gray scale of the first mixed image data to generate and output transformed data;
a second data smoother for modifying the transformed value of said each pixel according to the transformed data in the first area to generate second smoothed data;
a second mixing ratio generator for generating a second mixing ratio, the second mixing ratio increasing as the first maximum difference decreases; and
a second data mixer for mixing the transformed data and the second smoothed data according to the first mixing ratio to generate and output mixed output image data, the mixing proportion of the second smoothed data increasing as the first mixing ratio increases.

14. The image processing apparatus of claim 3, further comprising a gray-scale transformer for transforming a gray scale of the source data and outputting the transformed source data to the first data smoother and the first data mixer, wherein the first data smoother and the first data mixer operate on the transformed source data.

15. The image processing apparatus of claim 3, wherein the first area is a linear area extending in a first direction around said pixel, the image processing apparatus further comprising:
a second data smoother for modifying the first mixed image data of said each pixel according to the first mixed image data in a second area localized around the pixel to generate second smoothed data, the second area being a linear area extending in a second direction orthogonal to the first direction;
a second maximum difference calculator for calculating a second maximum difference between gray levels of the source data in the second area;
a second mixing ratio generator for generating a second mixing ratio, the second mixing ratio increasing as the second maximum difference decreases;
a second data mixer for mixing the first mixed image data and the second smoothed data according to the second mixing ratio to generate second mixed image data, the mixing proportion of the second smoothed data increasing as the second mixing ratio increases;
a gray-scale transformer for transforming a gray scale of the second mixed image data and outputting the transformed data;
a third data smoother for modifying the transformed data of said each pixel according to the transformed data in the first area to generate third smoothed data; and
a third data mixer for mixing the third smoothed data and the transformed data output according to the first mixing ratio to generate third mixed image data, the mixing proportion of the third smoothed data increasing as the first mixing ratio increases;
a fourth data smoother for modifying the third mixed image data of said each pixel according to the third mixed image data in the second area to generate fourth smoothed data; and
a fourth data mixer for mixing the third mixed image data and the fourth smoothed data according to the second mixing ratio to generate and output fourth mixed image data, the mixing proportion of the fourth smoothed data increasing as the second mixing ratio increases.

16. An image processing apparatus comprising:
a gray-scale transformer for receiving input image data and transforming a gray scale thereof to generate transformed data;
a data smoother for modifying the transformed data of said each pixel according to the transformed data in an area localized around the pixel to generate smoothed data;
a maximum difference calculator for calculating, for said each pixel, a maximum difference between gray levels of the input image data in said area;
a mixing ratio generator for generating a mixing ratio, the mixing ratio increasing as said maximum difference decreases; and
a data mixer for mixing the transformed data and the smoothed data according to said mixing ratio to generate and output mixed image data, the mixing proportion of the smoothed data increasing as the mixing ratio increases.

17. The image processing apparatus of claim 16, wherein the maximum difference is a maximum difference between pixels separated by not more than a predetermined distance within said area.

18. An image display apparatus comprising:
the image processing apparatus of claim 3;
a receiver for receiving an analog image signal and converting the analog image signal to n-bit digital image data for input to the image processing apparatus; and
a display unit for displaying an image according to the first mixed image data.

19. An image display apparatus comprising:
the image processing apparatus of claim 3;
a receiver for receiving an analog image signal and converting the analog image signal to n-bit digital image data for input to the image processing apparatus;
a gray-scale pseudo-enhancement processor for converting the first mixed image data from (n+α) bits per pixel to n bits per pixel, representing lost gray levels by distributions of output gray levels, to generate n-bit output image data; and
a display unit for displaying the n-bit output image data.
